(19) United States
(12) Patent Application Publication
(10) Pub. No.: US 2025/0031089 A1
(43) Pub. Date: Jan. 23, 2025

(54) SPARSITY-BASED ADVERSE WEATHER DETECTION

(71) Applicant: QUALCOMM Incorporated, San Diego, CA (US)

(72) Inventors: Ming-Yuan YU, Ann Arbor, MI (US); Senthil Kumar YOGAMANI, Headford (IE); Varun RAVI KUMAR, San Diego, CA (US)

(21) Appl. No.: 18/357,014

(22) Filed: Jul. 21, 2023

(51) Int. Cl. H04W 28/02

(52) U.S. Cl. CPC H04W 28/0242

(57) ABSTRACT

Aspects presented herein may enable a UE to detect and identify a weather condition of an environment based on the sparsity of FFT/DWT coefficients derived from a set of range images associated with the environment. In one aspect, a UE converts a set of point clouds associated with an environment to a set of range images based on a spherical projection. The UE applies at least one of FFT or DWT to the set of range images to obtain a set of FFT coefficients or a set of DWT coefficients. The UE identifies a level of a condition for the environment based on a sparsity of the set of FFT coefficients or the set of DWT coefficients.

### TECHNICAL FIELD

The present disclosure relates generally to communication systems, and more particularly, to a wireless communication involving camera-assisted positioning and ranging.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus converts a set of point clouds associated with an environment to a set of range images based on a spherical projection. The apparatus applies at least one of Fast Fourier Transform (FFT) or Discrete Wavelet Transform (DWT) to the set of range images to obtain a set of FFT coefficients or a set of DWT coefficients. The apparatus identifies a level of a condition for the environment based on a sparsity of the set of FFT coefficients or the set of DWT coefficients.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 illustrates an example of sidelink communication between devices in accordance with various aspects of the present disclosure.

FIG. 6 is a diagram illustrating an example of camera-aided positioning in accordance with various aspects of the present disclosure.

FIG. 7A is a diagram illustrating an example of a camera vision under a good/normal (e.g., non-adverse) weather condition in accordance with various aspects of the present disclosure.

FIG. 7B is a diagram illustrating an example of a camera vision under an adverse weather condition in accordance with various aspects of the present disclosure.

FIG. 8A is a diagram illustrating an example of a point cloud generated by a light detection and ranging (Lidar) sensor under a good/normal (e.g., non-adverse) weather condition in accordance with various aspects of the present disclosure.

FIG. 8B is a diagram illustrating an example of a point cloud generated by a Lidar sensor under an adverse weather condition in accordance with various aspects of the present disclosure.

FIG. 9 is a diagram illustrating an example of identifying/detecting a weather condition based on sparsity of a scene in accordance with various aspects of the present disclosure.

FIG. 10 is a diagram illustrating an example of identifying/detecting a weather condition based on sparsity of a scene in accordance with various aspects of the present disclosure.

FIG. 11 is a diagram illustrating an example of identifying/detecting a weather condition based on sparsity of a scene in accordance with various aspects of the present disclosure.

FIG. 12 is a diagram illustrating an example relationship between L1-norm of Fast Fourier Transform (FFT) or Discrete Wavelet Transform (DWT) (FFT/DWT) coefficients and weather conditions in accordance with various aspects of the present disclosure.

FIG. 13 is a diagram illustrating an example of using multiple range images from multiple ranging components for detecting the adverse weather condition in accordance with various aspects of the present disclosure.

FIG. 14 is a diagram illustrating an example of incorporating camera images with range images for contrastive representation learning in accordance with various aspects of the present disclosure.

FIG. 15 is a flowchart of a method of wireless communication.

FIG. 16 is a flowchart of a method of wireless communication.

FIG. 17 is a diagram illustrating an example of a hardware implementation for an example apparatus and/or network entity.

### DETAILED DESCRIPTION

Aspects presented herein may improve the accuracy and performance of a ranging operation and/or a positioning operation by enabling device(s), sensor(s), and/or component(s) used for the ranging/positioning operation to detect/determine the weather condition in real-time, such as adverse weather conditions. By enabling a device/sensor/component (e.g., a smart phone, a vehicle, an autonomous vehicle, a Lidar, a ranging component, etc.) to detect adverse weather conditions in real-time, the device/sensor/component may be able to make a more suitable scene reasoning and execute more proper control strategies under the detected adverse weather condition. For example, in one aspect of the present disclosure, a set of point clouds may be projected into a range view and thus be considered as two-dimensional (2D) tensors. Similarly, a sequence of range images may be considered as a three-dimensional (3D) tensor. The sparsity of tensors may be quantified as the L1-norm of the Fast Fourier Transform (FFT) or the Discrete Wavelet Transform (DWT) coefficients. By applying FFT and/or DWT to a sequence of range images, the sparsity of a scene may be quantified, where a sparser scene may indicate a lower likelihood of an adverse weather. In other words, by quantifying the sparsity of a scene, the presence of adverse weather conditions may be identified. In addition, in another aspect of the present disclosure, camera images collected during adverse weather conditions, though may be blurry, may still be incorporated in or used for a self-supervised fashion (e.g., for machine learning/artificial intelligence).

Aspects presented herein may not specify physical model of adverse weather conditions, meaning that it may be generalized to different ranging component (e.g., Lidar sensor) configurations if data (e.g., range images) is available. Unlike data-driven approaches, aspects presented herein may be unsupervised (which may also be referred to as weakly supervised), meaning that it may not specify a ground truth label or human intervention. Aspects presented herein may quantify the amount of sensory degradation at a granular level, instead of acting as a binary classifier (e.g., detecting the severity of the weather condition instead of classifying the weather as just good or bad). Aspects presented herein may be formulated as a multi-frame approach, enhancing temporal consistency. Aspects presented herein may also be extended to incorporating camera images if such data is available.

Aspects presented herein may apply to sensor suite equipped on vehicles depending on the quality of output prediction. The computation specifications for aspects presented herein may be very little and may be deployed on low-cost digital signal processors (DSPs). Aspects presented herein may enable downstream planning algorithm to switch/adjust to weather-specific control strategies for safe navigation in adverse weather conditions. If camera images are available, an image feature extractor may be trained for downstream vision-based tasks, including (but not limited to) initializing the encoder of a 3D object detection network.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

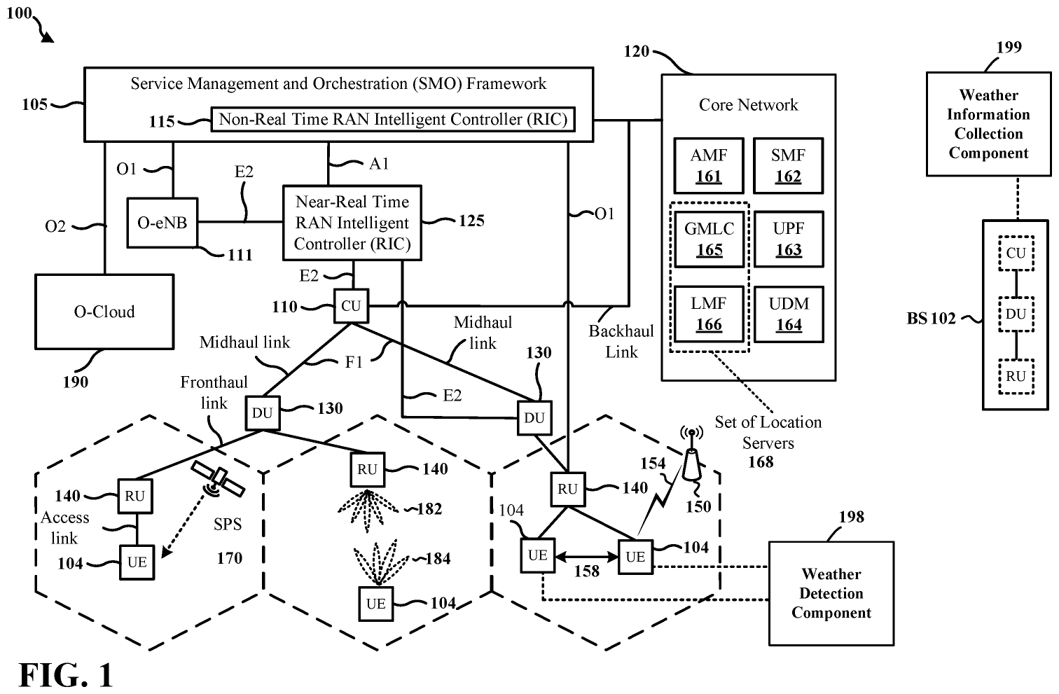

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHZ-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a weather detection component 198 that may be configured to convert a set of point clouds associated with an environment to a set of range images based on a spherical projection; apply at least one of FFT or DWT to the set of range images to obtain a set of FFT coefficients or a set of DWT coefficients; and identify a level of a condition for the environment based on a sparsity of the set of FFT coefficients or the set of DWT coefficients. In certain aspects, the base station 102 may include a weather information collection component 199 that may be configured to collect identified level of the condition for the environment from the UE 104 (e.g., based on crowdsourcing).

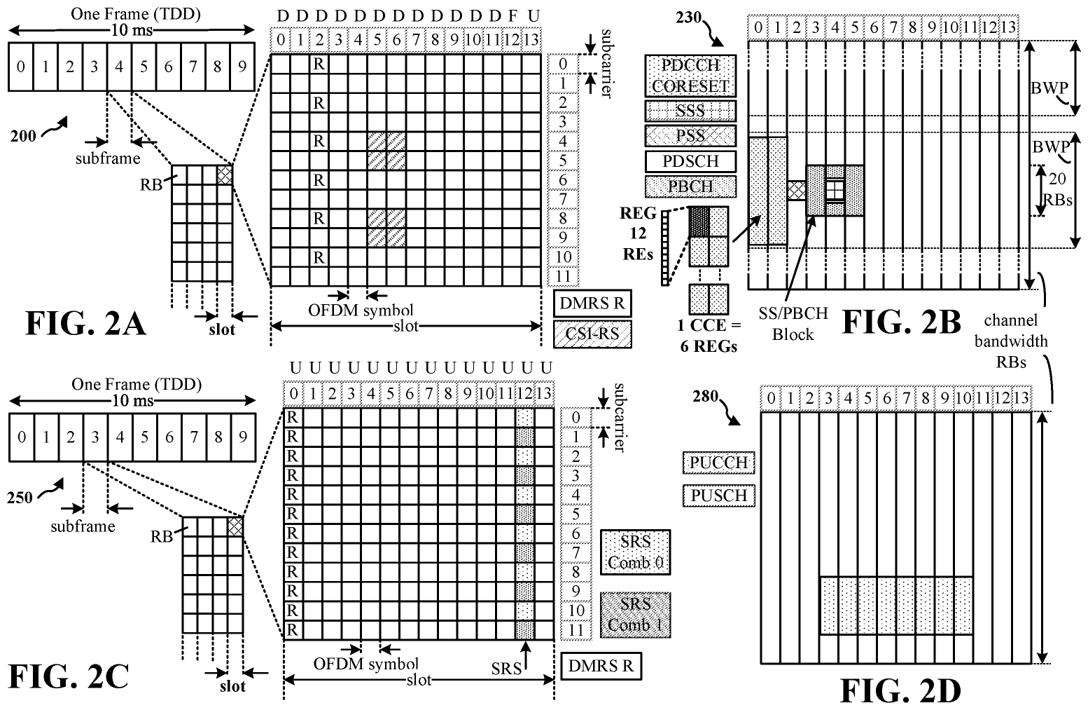

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A. 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| | Δƒ = | |
| μ | 2\hat{ }μ · 15 [kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2\hat{ }μ*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

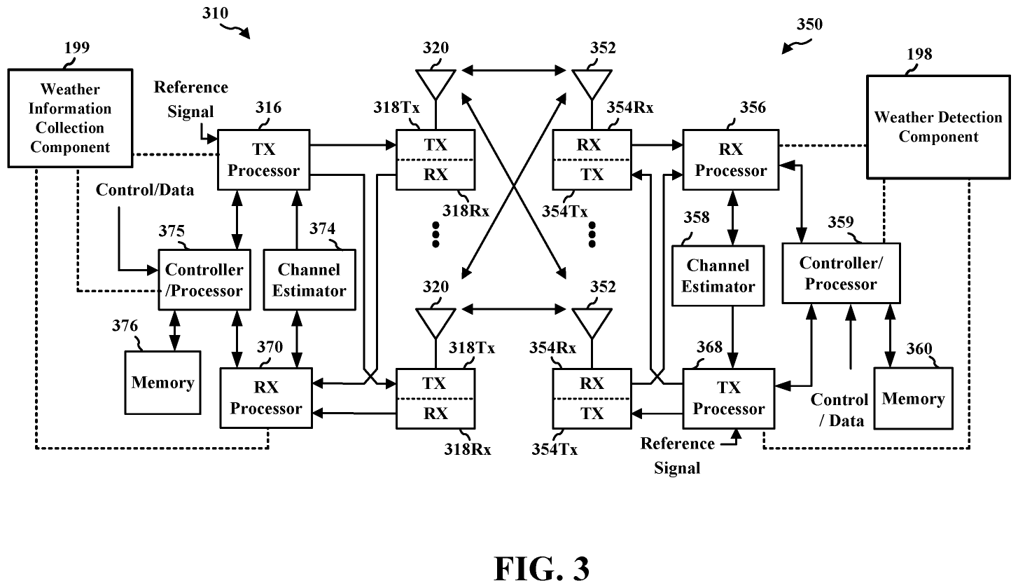

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the weather detection component 198 of FIG. 1.

At least one of the TX processor 316, the RX processor 370, and the controller/processor 375 may be configured to perform aspects in connection with the weather information collection component 199 of FIG. 1.

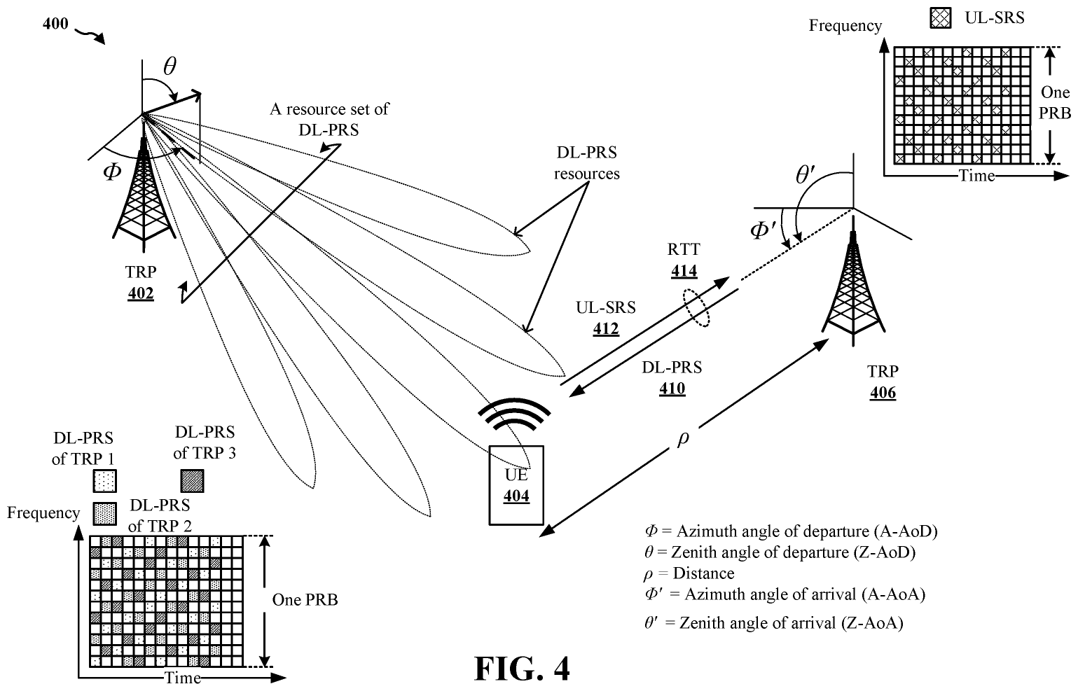

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402,406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR. TRS, PTRS, CRS, CSI-RS, DMRS, PSS. SSS. SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS. PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

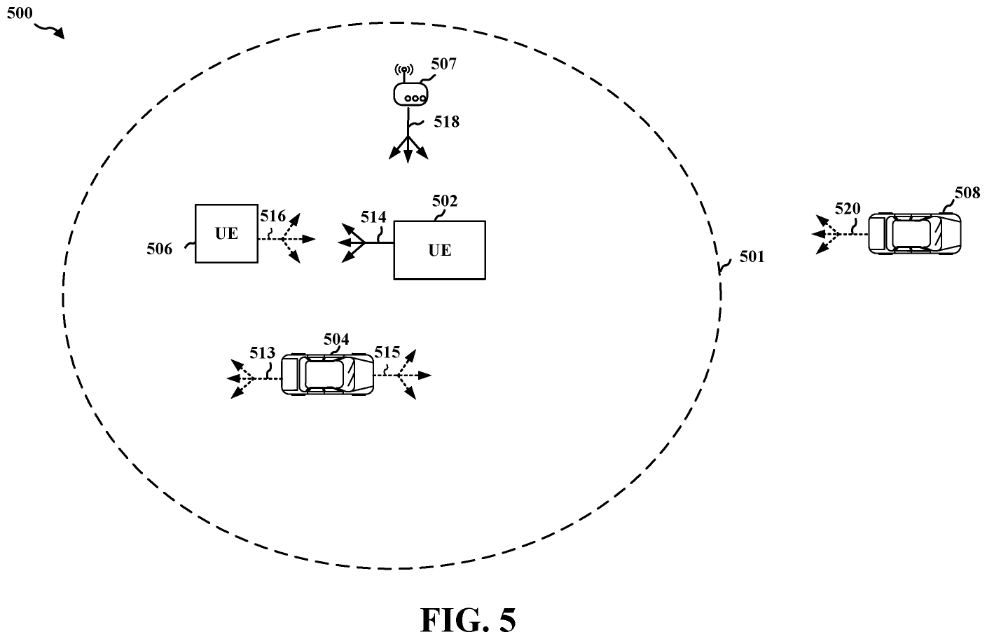

FIG. 5 illustrates an example 500 of sidelink communication between devices. In one example, the UE 502 may transmit a sidelink transmission 514, e.g., including a control channel (e.g., PSCCH) and/or a corresponding data channel (e.g., PSSCH), that may be received by UEs 504, 506, 508. A control channel may include information (e.g., sidelink control information (SCI)) for decoding the data channel including reservation information, such as information about time and/or frequency resources that are reserved for the data channel transmission. For example, the SCI may indicate a number of TTIs, as well as the RBs that may be occupied by the data transmission. The SCI may be used by receiving devices to avoid interference by refraining from transmitting on the reserved resources. The UEs 502, 504, 506, 508 may each be capable of sidelink transmission in addition to sidelink reception. Thus, UEs 504, 506, 508 are illustrated as transmitting sidelink transmissions 513, 515, 516, 520. The sidelink transmissions 513, 514, 515, 516, 520 may be unicast, broadcast or multicast to nearby devices. For example, UE 504 may transmit sidelink transmissions 513, 515 intended for receipt by other UEs within a range 501 of UE 504, and UE 506 may transmit sidelink transmission 516. Additionally, or alternatively, RSU 507 may receive communication from and/or transmit communication transmission 518 to UEs 502, 504, 506, 508. One or more of the UEs 502, 504, 506, 508 or the RSU 507 may include a weather detection component 198 as described in connection with FIG. 1.

Sidelink communication may be based on one or more transmission modes. In one transmission mode for a first radio access technologies (RAT) (which may be referred to herein as “Mode 4” of a first RAT), a wireless device may autonomously select resources for transmission. A network entity may allocate one or more sub-channels for wireless devices to transmit one or more transport blocks (TB) using the one or more channels. A wireless device may randomly reserve an allocated resource for one-shot transmissions. A wireless device may use a sensing-based semi-persistent transmission scheme, or semi-persistent scheduling (SPS) mode, to select a reserved resource for transmission. For example, before selecting a resource for data transmission, a wireless device may first determine whether resources have been reserved by another wireless device. Semi-persistent transmission allows a wireless device to take advantage of semi-periodic traffic arrival by using historical interference patterns to predict future interference patterns. The wireless device may sense at least one of priority information, energy sensing information, or PSCCH decoding information to optimize resource selection. In one aspect, a wireless device may avoid selecting resources for a transmission that are scheduled to be used for a higher priority packet transmission. In another aspect, a wireless device may rank resources according to how much energy is received, and may pick the lowest energy resources. In another aspect, a wireless device may avoid resources for whom control is decoded or for which the received energy may be above a threshold.

A network entity may configure the periodicity of the reserved sub-channels using DCI transmitted over a PDCCH. The period of a semi-persistent transmission resource may be, for example, 20, 50, 100, 200, 300, 400, 500, 600, 700, 800, 900, or 1000 milliseconds (ms). Such a periodicity may be referred to as a resource reservation period (RSVP). In alternative embodiments, the periodicity may be referred to as a resource reservation interval (RRI). A network entity may limit the possible values for the periodicity of the transmission resource. A wireless device, such as a UE, may select a transmission resource based on the periodicity of an arrival packet. A counter may be used to trigger periodic reselections. For example, a wireless device may randomly select a counter between 5 and 15, and may reserve a resource based on the counter (e.g., 10*counter resource reservation periods, a number of MAC protocol data unit (PDU) transmissions equal to the counter). After every transmission, or after a reservation period passes, the counter may be decremented until it hits zero. For example, where a reservation period is 100 ms and a counter is 10, every 100 ms the counter may decrement until one second(s) passes, upon which the wireless device may then reselect a sidelink resource. In one aspect, the wireless device may reselect the sidelink resource based on a re-selection probability value. For example, in response to the counter decrementing to zero, the wireless device may reselect the sidelink resource an x % of the time, and may not reselect the sidelink resource (1−x) % of the time, where x<1. The wireless device may then reset the counter and repeat the process when the counter decrements to zero again. A wireless device may measure a received signal strength indicator (RSSI) measurement for each slot of 100 ms, and may then calculate the RSSI of the frequency band resource as an average of each of the 10 RSSI measurements taken over the period of one second. A wireless device may select a preferred frequency band resource as a resource that is in one of the bottom 20% of ranked RSSI calculated resources for a wireless device. In some aspects, the counter may be decremented after every MAC PDU transmission. A wireless device may be configured to reselect a sidelink resource after a counter expires (i.e., reaches zero), and a MAC PDU is received.

Sidelink communication for other RATs may be based on different types or modes of resource allocation mechanisms. In another resource allocation mode for a second RAT (which may be referred to herein as “Mode 1” of a second RAT), centralized resource allocation may be provided by a network entity. For example, a network entity may determine resources for sidelink communication and may allocate resources to different wireless devices to use for sidelink transmissions. In this first mode, a wireless device may receive an allocation of sidelink resources from a base station. In a second resource allocation mode (which may be referred to herein as “Mode 2”), distributed resource allocation may be provided. In Mode 2, each wireless device may autonomously determine resources to use for sidelink transmission. In order to coordinate the selection of sidelink resources by individual wireless devices, each wireless device may use a sensing technique to monitor for resource reservations by other sidelink wireless devices and may select resources for sidelink transmissions from unreserved resources. Devices communicating based on sidelink, may determine one or more radio resources in the time and frequency domain that are used by other devices in order to select transmission resources that avoid collisions with other devices.

The sidelink transmission and/or the resource reservation may be periodic or aperiodic, where a wireless device may reserve resources for transmission in a current slot and up to two future slots (discussed below).

Thus, in the second mode (e.g., Mode 2), individual wireless devices may autonomously select resources for sidelink transmission, e.g., without a central entity such as a base station indicating the resources for the device. A first wireless device may reserve the selected resources in order to inform other wireless devices about the resources that the first wireless device intends to use for sidelink transmission(s).

In some examples, the resource selection for sidelink communication may be based on a sensing-based mechanism. For instance, before selecting a resource for a data transmission, a wireless device may previously determine whether resources have been reserved by other wireless devices.

For example, as part of a sensing mechanism for a resource allocation mode 2 of a second RAT, a wireless device may determine (e.g., sense) whether a selected sidelink resource has been reserved by other wireless device(s) before selecting a sidelink resource for a data transmission. If the wireless device determines that the sidelink resource has not been reserved by other wireless devices, the wireless device may use the selected sidelink resource for transmitting the data, e.g., in a PSSCH transmission. The wireless device may estimate or determine which radio resources (e.g., sidelink resources) may be in-use and/or reserved by others by detecting and decoding sidelink control information (SCI) transmitted by other wireless devices. The wireless device may use a sensing-based resource selection algorithm to estimate or determine which radio resources are in-use and/or reserved by others. The wireless device may receive SCI from another wireless device that may include reservation information based on a resource reservation field in the SCI. The wireless device may continuously monitor for (e.g., sense) and decode SCI from peer wireless devices. The SCI may include reservation information, e.g., indicating slots and RBs that a particular wireless device has selected for a future transmission. The wireless device may exclude resources that are used and/or reserved by other wireless devices from a set of candidate resources for sidelink transmission by the wireless device, and the wireless device may select/reserve resources for a sidelink transmission from the resources that are unused and therefore form the set of candidate resources. A wireless device may continuously perform sensing for SCI with resource reservations in order to maintain a set of candidate resources from which the wireless device may select one or more resources for a sidelink transmission. Once the wireless device selects a candidate resource, the wireless device may transmit SCI indicating its own reservation of the resource for a sidelink transmission. The number of resources (e.g., sub-channels per subframe) reserved by the wireless device may depend on the size of data to be transmitted by the wireless device. Although the example is described for a wireless device receiving reservations from another wireless device, the reservations may be received from an RSU or other device communicating based on sidelink.

A UE's position and/or a UE's range with respect to another UE may be determined/estimated based on sidelink (SL) communications. For example, two UEs may determine their locations (e.g., absolute locations) based on global navigation satellite system (GNSS), and the UEs may exchange their locations (e.g., their geographical longitude and latitude) with each other, such as via a vehicle-to-everything (V2X) safety message. Thus, a UE may obtain, or otherwise determine, its location based on the GNSS and may broadcast, or otherwise transmit, information about its location in a sidelink message. As such, each of the surrounding UEs may be able to determine the location of the UE transmitting its location, and/or may determine a range between itself and the UE transmitting its location. If each of the UEs in the area transmit their respective location information, a UE may determine distances to the surrounding UEs relative to its location. In another example, UEs may determine their relative distance to another UE(s) and/or their absolute positions (e.g., geographical locations) based on reference signals transmitted and received between the UEs over sidelink, where such ranging or positioning technique may be referred to as an SL-based ranging or positioning. The distance between UEs may be monitored for various reasons. In some applications, such as V2X, the distance between UEs may be monitored as a part of avoiding collisions, improving road user safety, etc. The SL-based ranging or positioning may provide a UE with an alternative or additional ranging/positioning mechanism when positioning based on GNSS is attenuated or unavailable (e.g., when the UE is in a tunnel, an urban area, a canyon, or a sheltered place, etc.). For example, the SL-based ranging or positioning may be used by UEs for public safety use cases when network service and/or other positioning services are not available. In other examples, if the GNSS is available, the SL-based ranging or positioning may further be used by a positioning device in addition to a GNSS-based positioning to enhance the accuracy of the GNSS-based positioning. In addition to Global Navigation Satellite Systems (GNSS)-based positioning and network-based positioning (e.g., as described in connection with FIG. 4), various camera-based positioning has also been developed to provide alternative/additional positioning mechanisms/modes. Camera-based positioning, which may also be referred to as “camera-based visual positioning,” “visual positioning” and/or “vision-based positioning,” is a positioning mechanism/mode that uses images captured by at least one camera to determine the location of a target (e.g., a UE or a transportation that is equipped with the at least one camera, an object that is in view of the at least one camera, etc.). For example, images captured by the dashboard camera (dash cam) of a vehicle may be used for calculating the three-dimensional (3D) position and/or 3D orientation of the vehicle while the vehicle is moving. For purposes of the present disclosure, a vehicle may refer to a thing used for transporting people or goods. Examples of a vehicle may include a car, a truck, a plane, a train, a cart, etc. Similarly, images captured by the camera of a mobile device may be used for estimating the location of the mobile device user or the location of one or more objects in the images. In some implementations, camera-based positioning may provide centimeter-level and 6-degrees-of-freedom (6DOF) positioning. 6DOF may refer to a representation of how an object moves through 3D space by either translating linearly or rotating axially (e.g., 6DOF=3D position+3D attitude). For example, a single-degree-of-freedom on an object may be controlled by the up/down, forward/back, left/right, pitch, roll, or yaw. Camera-based positioning has great potential for various applications, especially in satellite signal (e.g., GNSS/GPS signal) degenerated/unavailable environments.

In some scenarios, images captured by a camera may also be used for improving the accuracy/reliability of other positioning mechanisms/modes (e.g., the GNSS-based positioning, the network-based positioning, etc.) and/or positioning related sensors (e.g., IMU(s), Lidar(s), radar(s), etc.), which may be referred to as “vision-aided positioning,” “camera-aided positioning,” “camera-aided location,” and/or “camera-aided perception,” etc. For example, while GNSS and/or inertial measurement unit (IMU) may provide good positioning/localization performance, when GNSS measurement outage occurs, the overall positioning performance might degrade due to IMU bias drifting. Thus, images captured by the camera may provide valuable information to reduce errors. For purposes of the present disclosure, a positioning session (e.g., a period of time in which one or more entities are configured to determine the position of a UE) that is associated with camera-based positioning or camera-aided positioning may be referred to as a camera-based positioning session or a camera-aided positioning session. In some examples, the camera-based positioning and/or the camera-aided positioning may be associated with an absolute position of the UE, a relative position of the UE, an orientation of the UE, or a combination thereof.

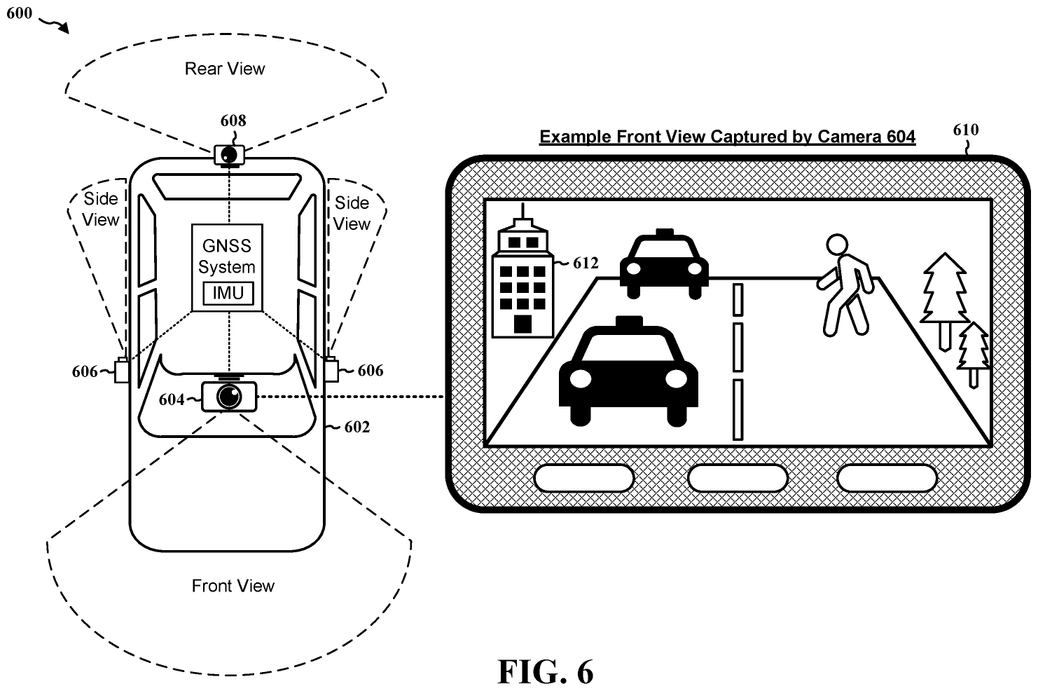

FIG. 6 is a diagram 600 illustrating an example of camera-aided positioning in accordance with various aspects of the present disclosure. A vehicle 602 may be equipped with a GNSS system and a set of cameras, which may include a front camera 604 (for capturing the front view of the vehicle 602), side cameras 606 (for capturing the side views of the vehicle 602), and/or a rear camera 608 (for capturing the front view of the vehicle 602), etc. The vehicle 602 may also include one or more ranging components. For purposes of the present disclosure, a ranging component may refer to any devices that are capable of detect/estimate a distance/range between the device and one or more objects. For example, a ranging component may be a radar, a camera (if the camera has the capability to determine the distance/depth of an object in images captured by the camera), a Lidar, an ultrasonic sensor, a sidelink transceiver, etc. Depending on implementations, a ranging component may also be referred to as a distance sensor, a sensing component/device, etc. In some examples, the GNSS system may further include or may be associated with at least one IMU (e.g., a GNSS+IMU system). While FIG. 6 uses the vehicle 602 as an example, it is merely for illustration purposes. Aspects presented herein may also apply to other types of transportations (e.g., motorcycles, bicycles, buses, trains, etc.), devices (e.g., UEs on pedestrians such as smart phone and smart watches), and/or positioning mechanisms/modes (e.g., network-based positioning described in connection with FIG. 4). In addition, for purposes of the present disclosure, a positioning mechanism/mode (e.g., GNSS-based positioning, network-based positioning, etc.) that uses at least one sensor (e.g., an IMU, a camera) to assist the positioning may be referred to as a sensor fusion positioning.

The GNSS system may estimate the location of the vehicle 602 based on receiving GNSS signals transmitted from multiple satellites (e.g., based on performing GNSS-based positioning). However, when the GNSS signals are not available or weak, such as when the vehicle 602 is in an urban area or in a tunnel, the estimated location of the vehicle 602 may become inaccurate. Thus, in some implementations, the set of cameras and/or other sensors/ranging components on the vehicle 602 may be used for assisting the positioning, such as for verifying whether the location estimated by the GNSS system based on the GNSS signals is accurate. For example, as shown at 610, images captured by the front camera 604 of the vehicle 602 may include/identify a specific building 612 (which may also be referred to as a feature) that is with a known location, and the vehicle 602 (or the GNSS system or a positioning engine associated with the vehicle 602) may determine/verify whether the location (e.g., the longitude and latitude coordinates) estimated by the GNSS system is in proximity to the known location of this specific building 612. Thus, with the assistance of the camera(s), the accuracy and reliability of the GNSS-based positioning may be further improved. For purposes of the present disclosure, a GNSS system that is associated with a camera (e.g., capable of performing camera-aided/based positioning) may be referred to as a “GNSS+camera system,” or a “GNSS+IMU+camera system” (if the GNSS system is also associated with/includes at least one IMU).

In some examples, a software or an application that accepts positioning related measurements from GNSS chipsets and/or sensors to estimate position, velocity, and/or altitude of a device may be referred to as a “positioning engine.” In addition, a positioning engine that is capable of achieving certain high level of accuracy (e.g., centimeter/decimeter level accuracy) and/or latency may be referred to as a precise positioning engine (PPE). For example, a positioning engine that is capable of performing real-time kinematic positioning (RTK) (e.g., receiving or processing correction data associated with RTK) may be considered as a PPE. Another example of PPE is a positioning engine that is capable of performing precise point positioning (PPP). PPP is a positioning technique that removes or models GNSS system errors to provide a high level of position accuracy from a single receiver.

While a ranging component on a device (e.g., a UE, a vehicle, etc.), such as a Lidar and/or a camera, may be used for detecting/estimating the distance between the device and one or more objects (or features of an object), the accuracy of the ranging component may be affected by weather conditions. For example, adverse weather conditions such as rain, fog, and/or snowfall may degrade the performance of the ranging component. In some examples, the performance may also be referred to as the “perception performance” (e.g., the ability for the device to perceive information related to its surrounding). Examples of a perception performance may include an object detection rate, the ability to quantify/detect changes in control characteristics (e.g., tire friction) from visual features, etc., of autonomous vehicles. For purposes of the present disclosure, an adverse weather or an adverse weather condition may refer to a damaging or potentially damaging weather event or environmental condition, which may include, but not limited to, rain, snow, fog, smog, air pollution, volcano eruption, hurricanes, floods, blizzards, disease, wildfires, extreme heat, and extreme cold, etc. Thus, an adverse weather or an adverse weather condition may not be limited to natural causes, but may also include human-made causes (e.g., pollutions). In some scenarios, detecting the presence of adverse weather condition(s) may be challenging based on using camera(s) due to motion blur and accretion on lenses, which may be caused by objects/properties associated with the adverse weather condition(s) (e.g., rain droplets, snowflakes, ashes, pollutions, etc.). On the other hand, a non-adverse weather condition, which may also be referred to as “a good weather condition,” “a normal weather condition,” and/or “a clear weather condition,” etc., may refer to a weather condition that does not create potential damages caused by an adverse weather condition.

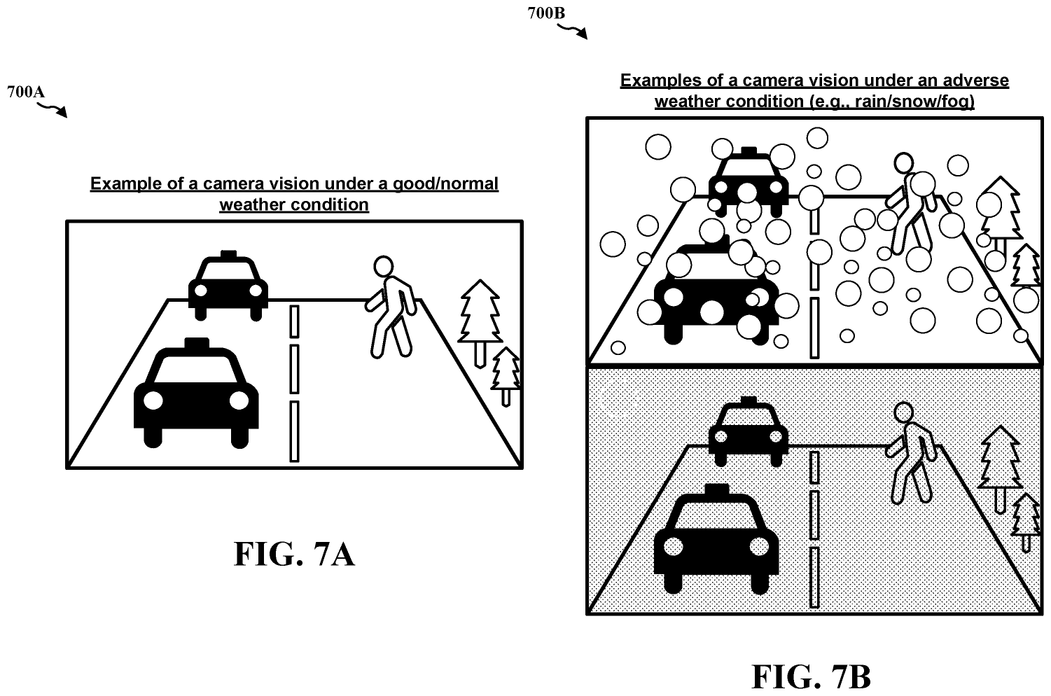

FIG. 7A is a diagram 700A illustrating an example of a camera vision under a good/normal (e.g., non-adverse) weather condition in accordance with various aspects of the present disclosure. Under a good/normal weather condition, images captured by a camera may depict objects in the images (e.g., cars, trees, pedestrians, etc.) with certain clarify (e.g., with a clear/complete contour of the object). FIG. 7B is a diagram 700B illustrating an example of a camera vision under an adverse weather condition in accordance with various aspects of the present disclosure. On the other hand, under an adverse weather condition, images captured by a camera may be fully or at least partially blocked by objects/particles associated with the adverse weather condition (e.g., snowflakes, rain droplets, fog/smog particles, volcano ashes, etc.).

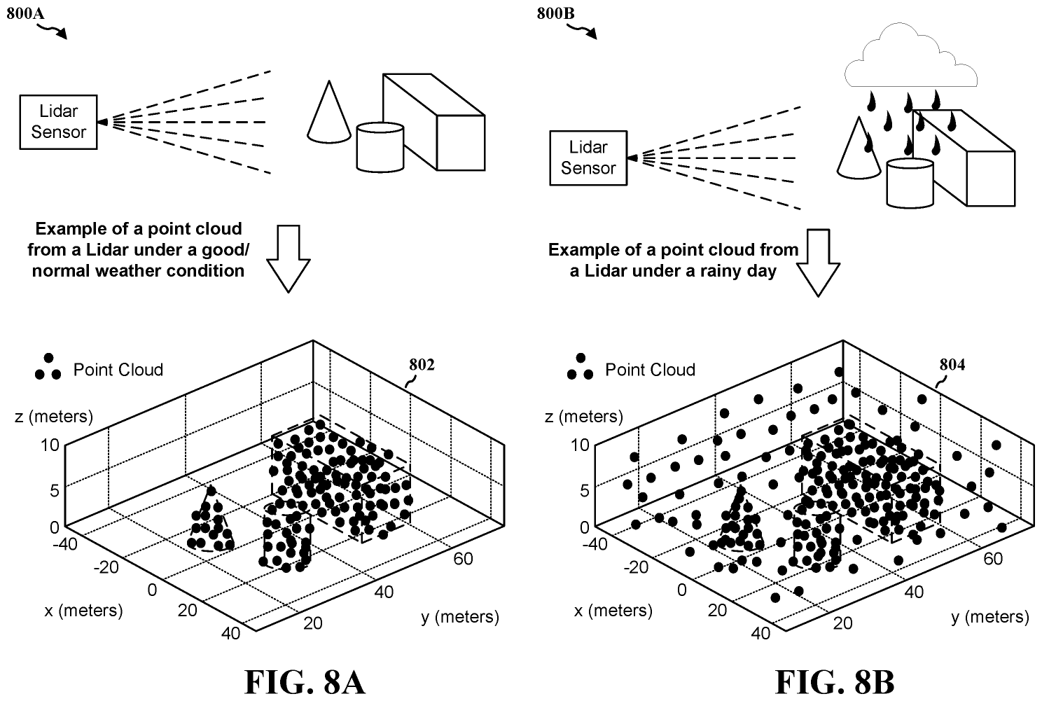

FIG. 8A is a diagram 800A illustrating an example of a point cloud generated by a Lidar sensor under a good/normal (e.g., non-adverse) weather condition in accordance with various aspects of the present disclosure. A Lidar, an acronym for light detection and ranging, is a type of ranging component/device that is capable of transmitting/illuminating laser light from a source (e.g., a transmitter), where the transmitted/illuminated laser light may reflect from one or more objects in a scene/environment. The reflected light may then be detected by a receiver of the Lidar and the time of flight (TOF) of the laser light may be used to develop a distance map of the one or more objects in the scene. In some examples, as shown at 802, the distance map of the one or more objects (or the surface of the one or more objects) may be represented by a set of points (e.g., a set of three-dimensional (3D) coordinates (X, Y, Z)), which may be referred to as a “point cloud.” Thus, a point cloud may be a 3D machine/computer vision that captures an object's location and shape in a format suitable for processing by a computer or a programmable logic controller (PLC)/programmable automation controller (PAC). As shown at 802, under a good/normal weather condition, the point cloud generated by a Lidar sensor for a set of objects (e.g., a cone, a cylinder, and a cuboid) may depict the shapes (e.g., the surfaces) of the set of objects with certain level of clarity.

FIG. 8B is a diagram 800B illustrating an example of a point cloud generated by a Lidar sensor under an adverse weather condition in accordance with various aspects of the present disclosure. On the other hand, as shown at 804, under an adverse weather condition, such as a rainy day, the point cloud generated by the Lidar sensor for the set of objects may be affected by the raindrops. Thus, the point cloud may not be able to depict the shapes (e.g., the surfaces) of the set of objects with good level of clarity.

In some examples, while certain devices may be configured to detect an adverse weather condition based on its associated physical properties (e.g., detecting a snow day based on physical properties of the snows), such devices typically do not take advantages of large public datasets. In addition, certain devices as Lidar sensors may be configured to process individual point cloud for various purposes such as for ranging detections, they typically do not utilize/analyze sequences of consecutive point clouds.

Aspects presented herein may improve the accuracy and performance of a ranging operation and/or a positioning operation by enabling device(s), sensor(s), and/or component(s) used for the ranging/positioning operation to detect/determine the weather condition in real-time, such as adverse weather conditions. By enabling a device/sensor/component to detect adverse weather condition in real-time, a UE (e.g., a smart phone, a vehicle, an autonomous vehicle, etc.) may be able to make a more suitable scene reasoning and execute more proper control strategies under the detected adverse weather condition. For example, in one aspect of the present disclosure, a set of point clouds may be projected into a range view and thus be considered as two-dimensional (2D) tensors. Similarly, a sequence of range images may be considered as a 3D tensor. The sparsity of tensors may be quantified as the L1-norm of the Fast Fourier Transform (FFT) or the Discrete Wavelet Transform (DWT) coefficients. By applying FFT and/or DWT to a sequence of range images, the sparsity of a scene may be quantified, where a sparser scene may indicate a lower likelihood of an adverse weather. In other words, by quantifying the sparsity of a scene, the presence of adverse weather conditions may be identified. In addition, in another aspect of the present disclosure, camera images collected during adverse weather conditions, though may be blurry, may still be incorporated in a self-supervised fashion (e.g., for machine learning/artificial intelligence). For purpose of the present disclosure, an FFT may refer to an algorithm that computes the discrete Fourier transform (DFT) of a sequence, or its inverse (IDFT). For example, Fourier analysis may convert a signal from its original domain (often time or space) to a representation in the frequency domain and vice versa. The DFT may be obtained by decomposing a sequence of values into components of different frequencies. A DWT may refer to any wavelet transform for which the wavelets are discretely sampled. As with other wavelet transforms, one difference it has over Fourier transforms is temporal resolution, e.g., it is capable of capturing both frequency and location information (location in time). FFT coefficients may refer to values (e.g., coefficients) obtained form the FFT. For example, when FFT is applied to a signal, the FFT calculates a set of complex numbers which may be referred to as coefficients. These coefficients (e.g., the FFT coefficients may represent the magnitude and phase information for different frequency components present in the signal. FFT coefficients may not have any temporal aspect, as they may take a whole signal as the input. So, the FFT is applied to a signal, just the contributions (e.g., magnitudes) from each frequency may be known, but where a particular frequency occurs in time may not be pinpointed. On the other hand, DWT coefficient may refer to values (e.g., coefficients) obtained from the DWT. When DWT is applied to a signal, the DWT decomposes the signal into a series of coefficients at different levels or scales. Each level may represent different level of detail or frequency band. The DWT may produce a set of approximation coefficients (e.g., representing low-frequency components) and detail coefficients (e.g., representing high-frequency components) for each level of decomposition. Therefore, DWT coefficients may contain temporal information of the analyzed signal.

Depending on context, sparsity may refer to a fact or condition of being thinly scattered or distributed and not thick or dense. In some examples, a sparsity may also refer to a density of a condition, and may be used interchangeably with the term density. For example, the sparsity of FFT/DWT coefficients may also refer to the density of FFT/DWT coefficients in some context. A range image may refer to an image that provides distance information between an object/feature and a reference point. For example, range images may be a class of digital images, where each pixel of a range image may express the distance between a known reference frame and a visible point in the scene. Therefore, a range image may reproduce the 3D structure of a scene. In other words, a range image is a representation of a scene or object that provides information about the distances from a sensor to various points in the scene. It is commonly used in fields such as computer vision, robotics, and 3D imaging. A range image may be obtained using range sensing techniques, such as Lidar or depth cameras. These sensors may be configured to emit signals (e.g., laser beams, infrared light, etc.) and measure the time it takes for the signals to bounce back after hitting objects in the scene. Based on the time-of-flight or phase shift of the returning signals, the sensor may calculate the distances to different points in the scene. In addition, a tensor may refer to a container of data, where the data may be numerical or character. Tensors may be represented as an array data structure. Tensors may be used to represent data in a variety of ways, including as a sequence, as a graph, or as a set of points in space. In data science and machine learning (ML) or artificial intelligence (AI), tensors may be used to represent high-dimensional data. Tensors may also be used to represent complex relationships between variables. For example, in machine learning, tensors may be used to represent the weights of a neural network. In some examples, a two-dimensional (2D) array (which may also be called as a matrix) may be referred to as a 2D-tensor. Similarly, a three-dimensional (3D) array may be referred to as a 3D-tensor. An L1-norm (or L1 normalization) may refer to the sum of a set absolute values (or absolute vector values), where the absolute value of a scalar may use the notation |a1|.

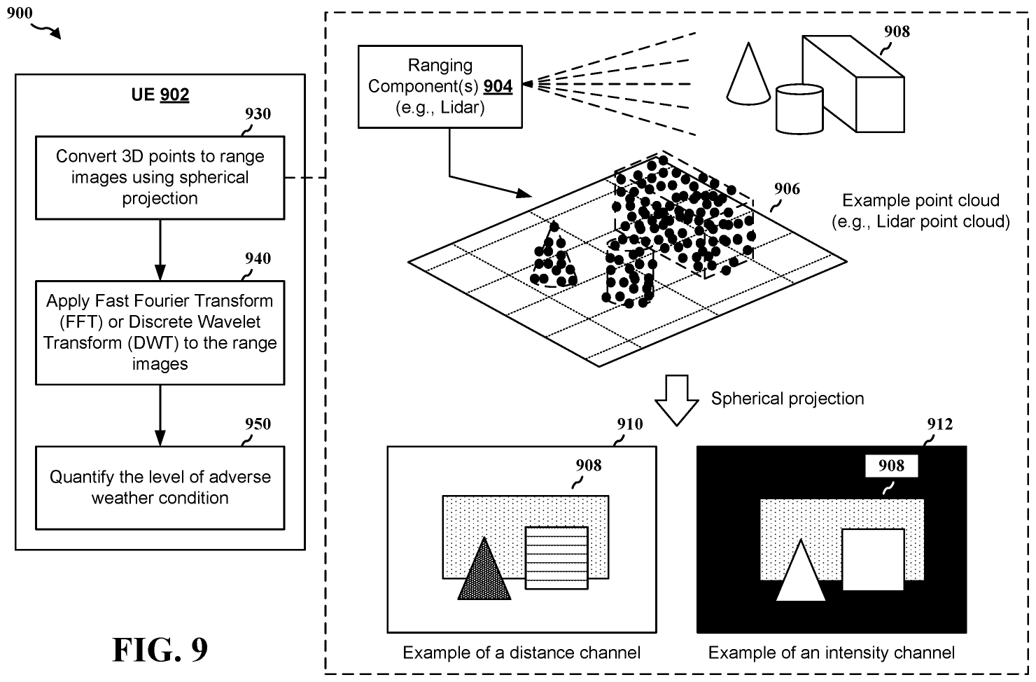

FIGS. 9, 10, and 11 are diagrams 900, 1000, and 1100, respectively, illustrating an example of identifying/detecting a weather condition based on sparsity of a scene in accordance with various aspects of the present disclosure. A UE 902 (e.g., a smartphone, a vehicle, a vehicle UE, an autonomous vehicle, etc.) may be associated/equipped with one or more ranging components 904, such as a set of Lidar sensors. As shown at 906 (and also described in connection with FIGS. 8A), the one or more ranging components 904 may detect ranges of one or more objects 908 in its surrounding (or features of the one or more objects 908), and may generate a point cloud representing those objects/features. The surrounding of the UE 902 (e.g., including the one or more objects 908) may collectively be referred to as a scene or an environment around the UE 902 for purposes of the present disclosure.

In one aspect, as shown at 930 of FIG. 9, to enable or train the UE 902 to identify/detect a weather condition based on sparsity of a scene/environment, the UE 902 may first convert point cloud (e.g., 3D points) generated from the one or more ranging components 904 into a set of range images, such as based on using a spherical projection. A spherical projection (which may also be referred to as a front view projection in some examples) may refer to a way to represent a 3D point cloud data into 2D image data, and so the spherical projection may also act as a dimensionality reduction method. In other words, the UE 902 may convert the 3D point cloud into 2D images via using the spherical projection. In one example, as shown at 910, the 2D image (or the 2D range image) may include a distance channel, which shows the distance of the one or more objects 908 from the UE 902 (or from the one or more ranging components 904). For example, the distance of the one or more objects 908 from the UE 902 may be represented with different colors, where a darker color may indicate an object (or a point representing the object) is closer to the UE 902 and a lighter color may indicate an object (or a point representing the object) is further away from the UE 902 compared to the darker color. In another example, as shown at 912, the 2D image (or the 2D range image) may include an intensity channel, which shows the intensity of the one or more objects 908 from the UE 902 (or from the one or more ranging components 904). The intensity may refer to the brightness of the reflected laser signals. For example, objects that tend to reflect light/laser beams (e.g., road/stop sign, cat eyes, road/lane markers, etc.) may be represented with a brighter color, whereas objects that tend to absorb light or not reflect light (e.g., black paint, coals, etc.) may be represented with a darker/less bright color compared to objects that tend to reflect light.

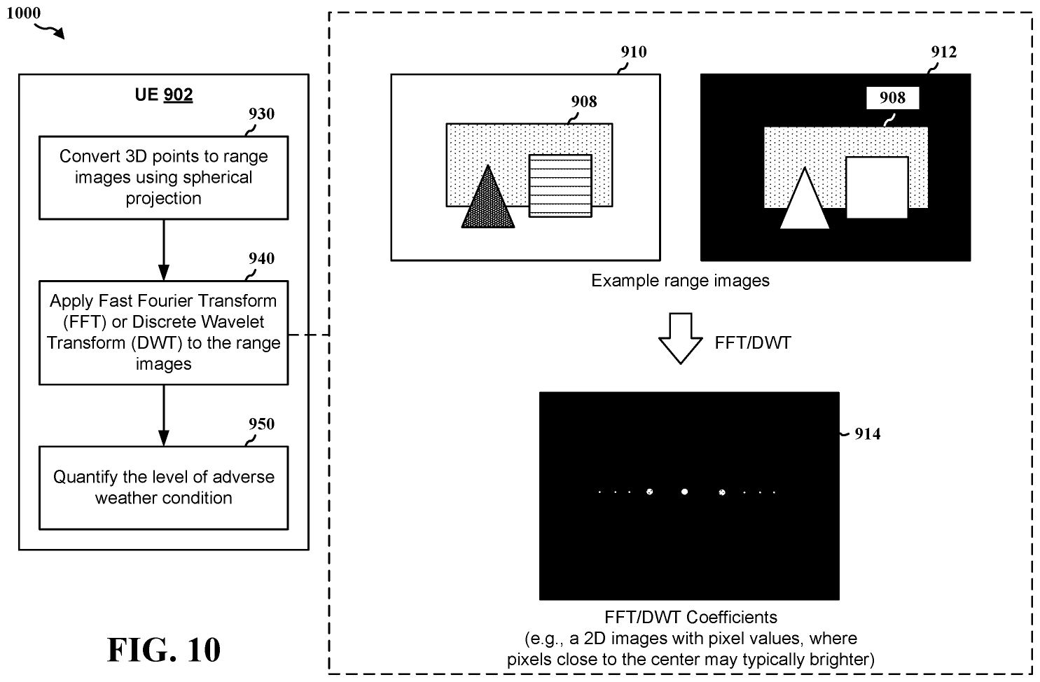

As shown at 940 of FIG. 10, after the UE 902 converts the point cloud to a set of range images, the UE 902 may apply Fast Fourier Transform (FFT) and/or Discrete Wavelet Transform (DWT) to the set of range images and convert the set of range images to a set of FFT/DWT coefficients (which may also in a form of an image), such as shown at 914.

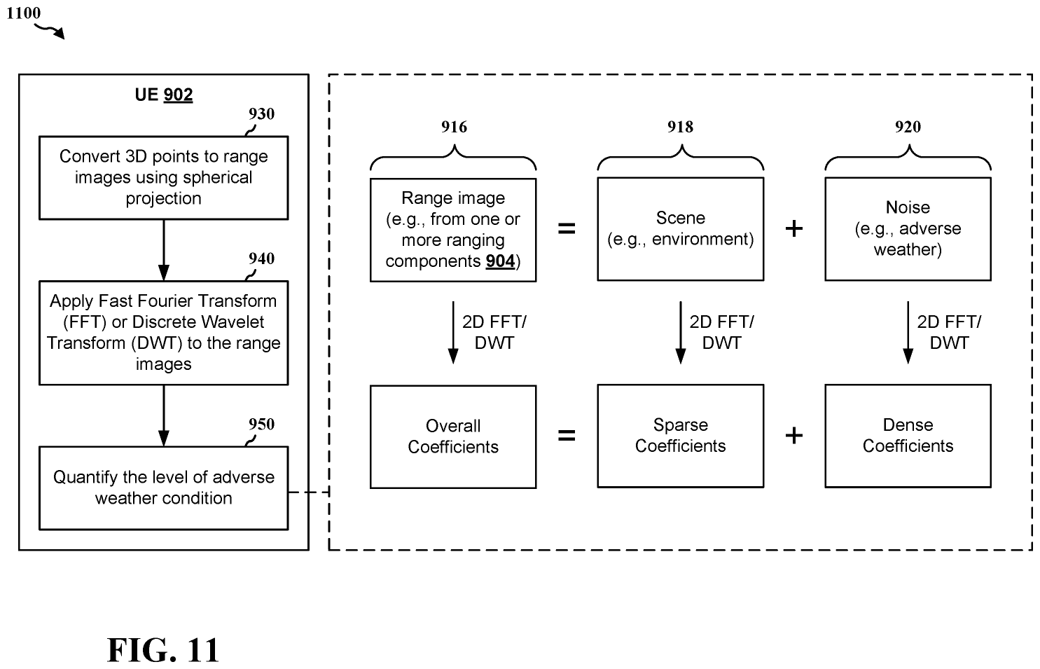

Then, as shown at 950 of FIG. 11, after the set of range images are converted to a set of FFT/DWT coefficients, the UE 902 may quantify the level of adverse weather condition based on the set of FFT/DWT coefficients. In one example, as shown at 916, each range image in the set of range images or its corresponding overall FFT/DWT coefficients may compose two parts: a scene and a noise. As shown at 918, the FFT/DWT coefficients for the scene, which may include the one or more objects 908 (e.g., buildings, road surfaces, vehicles, pedestrians, etc.), are likely to be sparse coefficients. On the other hand, as shown at 920, the FFT/DWT coefficients for the noise (e.g., referring to things/particles associated with adverse weather conditions such as droplets, fog, snowflakes, etc.) are likely to be dense/denser coefficients compared to the scene. As such, the UE 902 may be able to identify whether a range image is associated with just a scene (e.g., likely under a good/normal weather condition) or is associated with both a scene and a noise (e.g., likely under an adverse weather condition) based on the sparsity of the FFT/DWT coefficients.

In other words, as FFT and DWT may generate sparse representations for uncorrupted images (e.g., scenes without noise) and dense representations for noises, they may be used for identifying the weather condition. For example, the sparsity of FFT/DWT coefficients may be measured by the L1-norm, and the overall coefficients may serve as a proxy to the presence of the noise. Then, given a similar scene, the overall coefficients may become denser when the level of noise increases. On the other hand, having sparser overall coefficients may indicate a lower level of noise from adverse weather conditions.

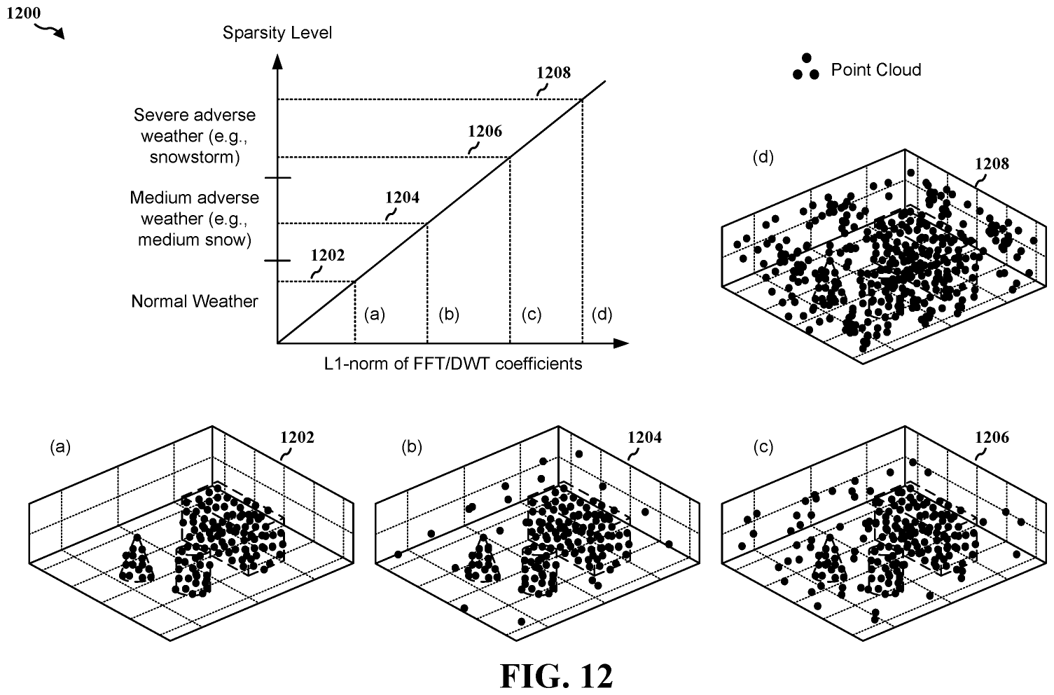

FIG. 12 is a diagram 1200 illustrating an example relationship between L1-norm of FFT/DWT coefficients and weather conditions in accordance with various aspects of the present disclosure. In general, noisy range images (e.g., referring to images corrupted by adverse weather conditions) tend to be denser. Thus, their FFT/DWT coefficients are likely to have larger L1-norm. Conversely, point clouds/range images with lower L1-norm are likely to uncorrupted (e.g., not being corrupted by adverse weather conditions). For example, as shown at 1202, a point cloud without noise may have a low L1-norm of FFT/DWT coefficients, which may indicate the weather condition is good/normal. As shown at 1204, a point cloud with some noise may have a higher L1-norm of FFT/DWT coefficients compared to the point cloud without noise, which may indicate there is a medium adverse weather condition (e.g., medium snow, medium rain, etc.). As shown at 1206 and 1208, point clouds with high level amount of noises may have a much higher L1-norm of FFT/DWT coefficients compared to the point cloud without noise or with some noise, which may indicate there is a server adverse weather condition (e.g., a snowstorm, a hurricane, etc.). Thus, in some scenarios, the granularity of the weather condition may be proportional to the L1-norm of FFT/DWT coefficients (e.g., the higher the L1-norm, the severer the adverse weather condition).

In some implementations, after the UE 902 detects and identifies the weather conditions in a scene/area (e.g., based on the sparsity of the L1-norm of FFT/DWT coefficients derived from the range images of the scene/area), the UE 902 may transmit the detected/identified weather conditions of the scene/area to a server (e.g., a location server, a crowdsourcing server, etc.). This information may be shared with other UEs in the scene/area (or in proximity/heading to the scene/area), such that these UEs may be aware of the weather conditions, which may be helpful for UEs that are not capable of identifying the weather conditions. For example, after an autonomous vehicle learns the adverse weather conditions for an area (e.g., through the server), the autonomous vehicle may apply suitable driving settings/parameters when entering the area. In some examples, after the UE 902 detects and identifies the weather conditions, the UE 902 may also modify certain parameters based on the identified weather condition. For example, if the UE 902 is a vehicle, such as an autonomous vehicle, the UE 902 may modify its driving/control parameters and/or safety features based on the identified weather condition.

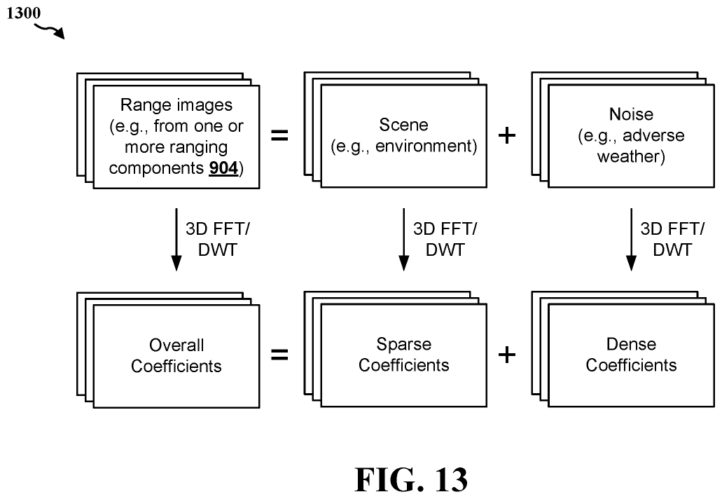

FIG. 13 is a diagram 1300 illustrating an example of using multiple range images from multiple ranging components for detecting the adverse weather conditions in accordance with various aspects of the present disclosure. In another aspect of the present disclosure, when one or more ranging components (e.g., Lidar sensors) are configured to capture/obtain a series of consecutive range images (e.g., via multiple timestamps) and/or a set of range images via multiple ranging components, in addition to the range image with a single-frame formulation as shown by FIG. 11 (e.g., using ranging images of one timestamp or one point in time for weather condition identification), the UE 902 may use multiple frames from a series of consecutive range images (e.g., taken by one ranging component) to enhance the temporal consistency (and also accuracy of the adverse weather detection). For examples, multiple range images generated from different timestamps of a Lidar sensor or a plurality of Lidar sensors are likely to be more accurate (for detecting adverse weather) compared to range image(s) generated from one point in time. In some examples, the multi-frame formulation (e.g., the use of multiple range images from multiple timestamps) may specify the UE 902 to use 3D FFT and/or 3D DWT to convert the ranges images to FFT/DWT coefficients. Similarly, high/denser FFT/DWT coefficients may indicate there is an adverse weather condition, and low/sparser FFT/DWT coefficients may indicate there is a normal/non-adverse weather condition.

In some configurations, when a vehicle is equipped with multiple ranging components (e.g., multiple Lidar sensors), each ranging component may be configured to be associated with a confidence level or a weight, and different ranging components may have different confidence. For example, if a vehicle includes a first Lidar sensor and a second Lidar sensor, where the first Lidar sensor is cheaper in cost compared to the second sensor Lidar (and thereby likely has a lower accuracy compared to the second Lidar sensor), a higher confidence level or weight may be assigned to the second Lidar sensor whereas a lower confidence level or weight may be assigned to the first Lidar sensor (compared to the second Lidar sensor). Then, if both Lidar sensors are used for calculating the sparsity (of a scene), a final sparsity may be calculated based on the confidence levels/weights, e.g., final sparsity=weight of the first Lidar sensor*(sparsity estimation from the first Lidar sensor)+weight of the second Lidar sensor*(sparsity estimation from the second Lidar sensor), where “weight of the second Lidar sensor” and “weight of the second Lidar sensor” are the weights (i.e., confidence levels) that may be added up to one or a specified number. As such, aspects presented herein may apply to multiple ranging components with different costs and accuracies, which may reduce the implementation cost of the disclosure.

In some implementations, if a vehicle is equipped with multiple ranging components that are associated with different confidence levels (e.g., have different accuracies and costs), the vehicle may also be configured to use ranging components that has a confidence level above a confidence level threshold. As such, the vehicle may avoid using ranging component(s) with low confidence level(s) which may impact the accuracy of weather condition detection.

In another aspect of the present disclosure, based on enabling a device (e.g., the UE 902) to detect and identify a weather condition in a scene based on the sparsity associated with the scene (or associated with the FFT/DWT coefficients derived from the scene), the range image(s) from ranging components (e.g., the one or more ranging components 904) may be incorporated with camera images for contrastive representation learning. Contrastive representation learning (or simply contrastive learning) may refer to a technique that enhances the performance of vision tasks by using the principle of contrasting samples against each other to learn attributes that are common between data classes and attributes that set apart a data class from another.

For example, camera images (e.g., captured by one or more camera associated with a device) in adverse weather conditions are likely to be blurry due to lens accretion (e.g., droplets, snowflakes, and/or fog particles blocking the lens), but they may still provide useful information (e.g., for identifying traffic light, moving objects, etc.). Thus, the L1-norm of range images, such as Lidar range images described in connection with FIGS. 9 and 10, may be used to construct positive and negative pairs for the triplet loss with a learnable feature extractor. Triplet loss may refer to a way to teach a machine-learning (ML)/artificial intelligence (AI) model how to recognize the similarities or differences between items. The triplet loss may use groups of three items, called triplets, which consist of an anchor item (denoted by (A)), a similar item (positive, denoted by (P)), and a dissimilar item (negative, denoted by (N)).

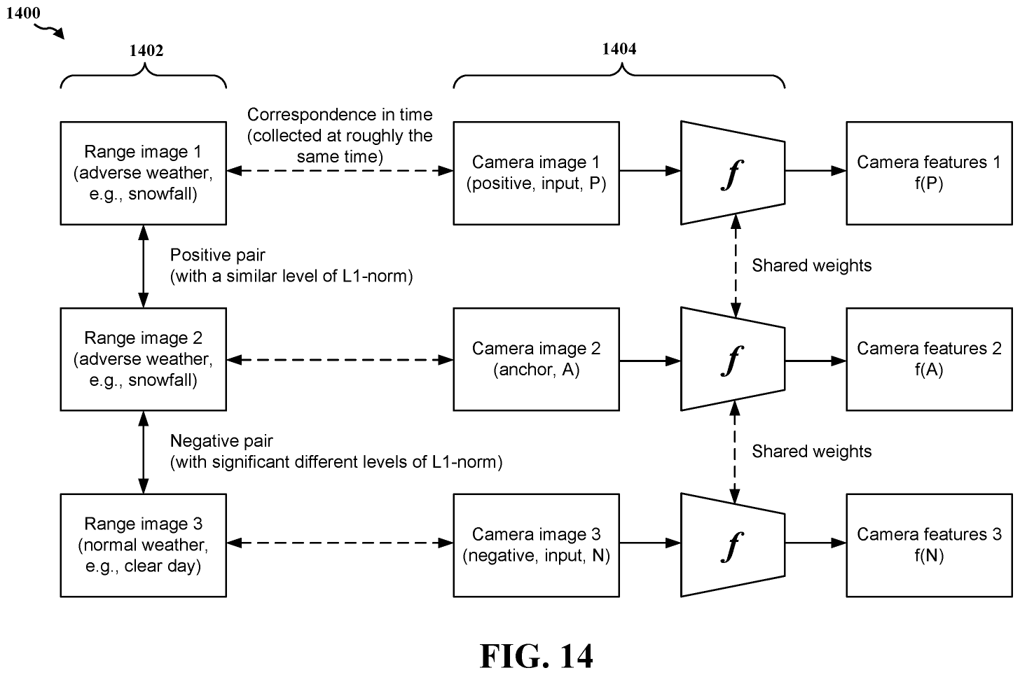

FIG. 14 is a diagram 1400 illustrating an example of incorporating camera images with range images for contrastive representation learning in accordance with various aspects of the present disclosure. In one example, the triplet loss function (with a learnable feature extractor) may be described by means of the Euclidean distance function (ƒ): L(A,P,N)=max(∥ƒ(A)−ƒ(P)∥²−∥ƒ(A)−ƒ(N)∥²+α,0). As shown at 1402, a group of three range images may be used for construct positive and negative pairs for the triplet loss, where a first range image (range image 1) may be associated with an adverse weather (e.g., snowfall), a second range image (range image 2) may be associated with an adverse weather (e.g., snowfall), and a third range image (range image 3) may be associated with a normal/non-adverse weather (e.g., a clear day). Based on obtaining the L1-norm for the FFT/DWT coefficients for the range images as described in connection with FIG. 11, the first range image and the second range image (also the anchor) may form a positive pair as their L1-norm are likely to be similar/closer to each other, and the second image and the third image may form a negative pair as they are likely to have different levels of the L1-norm. As shown at 1404, based on the pairing, corresponding camera images (e.g., taken approximately by a camera at the same time and at the same/similar geolocations as the range image from a Lidar sensor) may be used for providing useful information and/or extracting features (e.g., having cameras and Lidar sensors on the same vehicle, or having them on different vehicles that was traveling in the same city, etc.). For example, by knowing that a camera image is associated with certain weather conditions, an AI/ML module may be configured to learn the inherited properties of different weather conditions (e.g., blurriness, color/intensity distributions, etc.) to help downstream tasks, like developing a robust object detector that performs equally well under different weather conditions. Thus, a feature extractor may be used in downstream tasks, such as initializing the encoder of a 3D object detection network.

Aspects presented herein may improve the performance of ranging components/devices. For example, perception performance of autonomous vehicles degrades under adverse weather. Detecting the presence of adverse weather can be challenging using cameras due to motion blur and accretion (due to droplets and snowflakes). Conventional approaches model physical properties of snowfall, but fail to take advantage of public datasets. Also, conventional approaches focus on processing individual point cloud, but not sequences of consecutive point clouds. Aspects described herein may propose to project point clouds into the range of view and thus be considered as a 2D tensor. Sparsity of the scene may be determined by applying FFT and DWT techniques to a range image or a set of range images, and by quantifying sparsity, the presence of adverse weather conditions may be identified.

Aspects presented herein may not specify any physical model of adverse weather conditions, meaning that it may easily be generalized to different ranging component (e.g., Lidar sensor) configurations as long as data (e.g., range image) is available. Unlike other data-driven approaches, aspects presented herein may be unsupervised, meaning that it may not specify a ground truth label. Aspects presented herein may quantify the amount of sensory degradation at a granular level, instead of acting as a binary classifier (e.g., detecting the severity of the weather condition instead of classifying the weather as just good or bad). Aspects presented herein may be formulated as a multi-frame approach, enhancing temporal consistency. Aspects presented herein may also be extended to incorporating camera images if such data is available.

Aspects presented herein may apply to sensor suite equipped on vehicles depending on the quality of output prediction. The computation specifications for aspects presented herein may be very little and may be deployed on low-cost digital signal processors (DSPs). Aspects presented herein may enable downstream planning algorithm to switch/adjust to weather-specific control strategies for safe navigation in adverse weather conditions. If camera images are available, an image feature extractor may be trained for downstream vision-based tasks, including (but not limited to) initializing the encoder of a 3D object detection network.

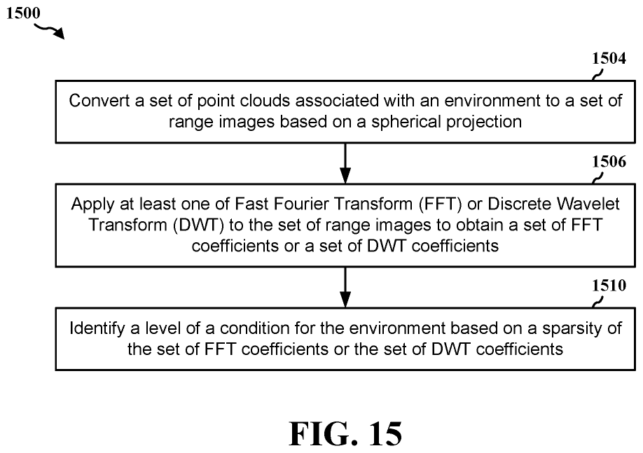

FIG. 15 is a flowchart 1500 of a method of wireless communication. The method may be performed by a UE (e.g., the UE 104, 404, 502, 506, 508, 902; the vehicle 602; the apparatus 1704). The method may enable the UE to detect and identify a weather condition based on the sparsity of FFT/DWT coefficients derived from a set of range images.

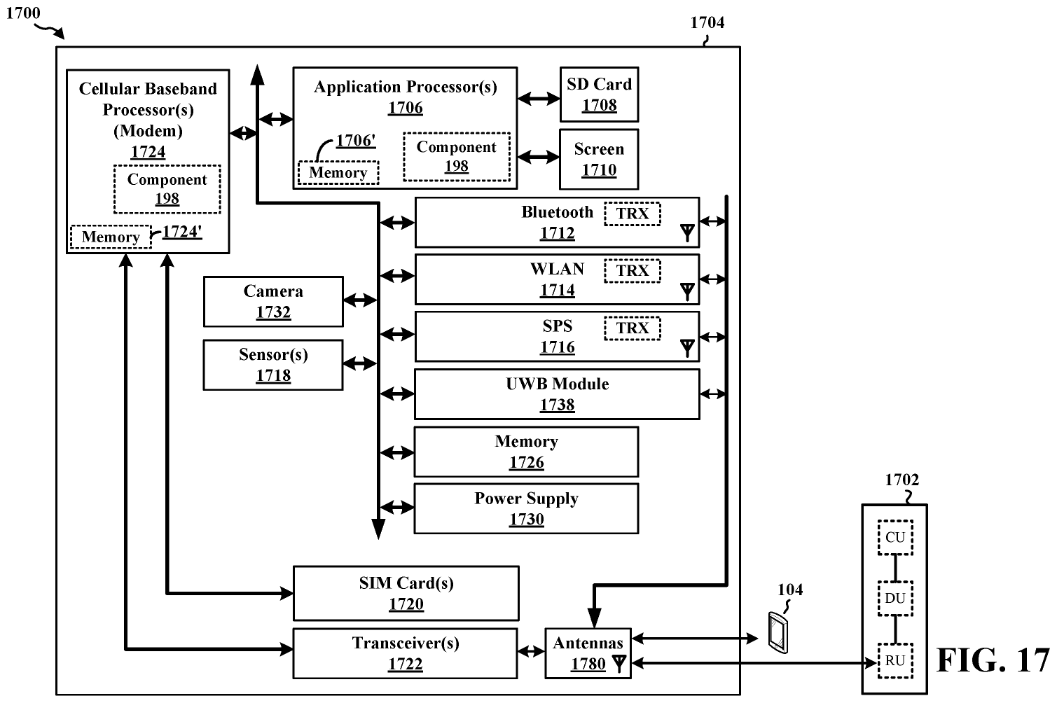

At 1504, the UE may convert a set of point clouds associated with an environment to a set of range images based on a spherical projection, such as described in connection with FIGS. 9-13. For example, as shown at 930 of FIG. 9, the UE 902 may convert a point cloud to a set of range images based on spherical projection. The conversion of the set of point clouds may be performed by, e.g., the weather detection component 198, the one or more sensor modules 1718 (e.g., one or more Lidar sensors), the camera 1732, the transceiver(s) 1722, the cellular baseband processor(s) 1724, and/or the application processor(s) 1706 of the apparatus 1704 in FIG. 17.

At 1506, the UE may apply at least one of FFT or DWT to the set of range images to obtain a set of FFT coefficients or a set of DWT coefficients, such as described in connection with FIGS. 9-13. For example, as shown at 940 of FIG. 10, the UE 902 may apply FFT and/or DWT to the set of range images to obtain a set of FFT/DWT coefficients. The application of the FFT or DWT may be performed by, e.g., the weather detection component 198, the one or more sensor modules 1718 (e.g., one or more Lidar sensors), the camera 1732, the transceiver(s) 1722, the cellular baseband processor(s) 1724, and/or the application processor(s) 1706 of the apparatus 1704 in FIG. 17.

At 1510, the UE may identify a level of a condition for the environment based on a sparsity of the set of FFT coefficients or the set of DWT coefficients, such as described in connection with FIGS. 9-13. For example, as shown at 950 of FIG. 11 and FIG. 12, the UE 902 may determine a weather condition based on the sparsity of the FFT/DWT coefficients. The identification of the level of the condition for the environment may be performed by, e.g., the weather detection component 198, the one or more sensor modules 1718 (e.g., one or more Lidar sensors), the camera 1732, the transceiver(s) 1722, the cellular baseband processor(s) 1724, and/or the application processor(s) 1706 of the apparatus 1704 in FIG. 17.

In one example, the condition may be an adverse weather condition or a clear weather condition, and to identify the level of the condition for the environment, the UE may identify the level of the adverse weather condition or the clear weather condition.

In another example, the sparsity of the set of FFT coefficients or the set of DWT coefficients may be based on an L1 norm.

In another example, the condition may be an adverse weather condition, and the adverse weather condition is more severe when the set of FFT coefficients or the set of DWT coefficients is denser compared to the set of FFT coefficients or the set of DWT coefficients that is less dense.

In another example, the set of point clouds corresponds to a 3D visualization of the environment that comprises a plurality of georeferenced points.

In another example, the UE may modify at least one control parameter of a vehicle based on the identification of the level of the condition for the environment.

In another example, the UE may obtain, from at least one sensor, the set of point clouds associated with the environment prior to the conversion of the set of point clouds, where the conversion of the set of point clouds may be based on the obtained set of point clouds, such as described in connection with FIGS. 9-13. For example, as shown by FIG. 9, the UE 902 may obtain the point cloud for one or more objects 908 using one or more ranging components 904. The obtaining of the set of point clouds may be performed by, e.g., the weather detection component 198, the one or more sensor modules 1718 (e.g., one or more Lidar sensors), the camera 1732, the transceiver(s) 1722, the cellular baseband processor(s) 1724, and/or the application processor(s) 1706 of the apparatus 1704 in FIG. 17. In some implementations, the at least one sensor includes at least one light detection and ranging (Lidar) sensor. In some implementations, the UE may obtain the set of range images via multiple timestamps of one or more Lidar sensors, and to applying at least one of the FFT or the DWT to the set of range images, the UE may apply at least one of a three-dimensional (3D) FFT or a 3D DWT to the set of range images.

In another example, the UE may detect the sparsity of the set of FFT coefficients or the set of DWT coefficients prior to the identification of the level of the condition for the environment, where the identification of the level of the condition for the environment is based on the detected sparsity of the set of FFT coefficients or the set of DWT coefficients, such as described in connection with FIGS. 9-13. For example, as shown by FIG. 12, the UE 902 may detect the sparsity of the FFT/DWT coefficients for a scene/environment, where the weather condition (or the level of the adverse weather condition) may be based on the sparsity of the FFT/DWT coefficients or the set of DWT coefficients. The detection of the sparsity of the set of FFT/DWT coefficients may be performed by, e.g., the weather detection component 198, the one or more sensor modules 1718 (e.g., one or more Lidar sensors), the camera 1732, the transceiver(s) 1722, the cellular baseband processor(s) 1724, and/or the application processor(s) 1706 of the apparatus 1704 in FIG. 17.

In another example, the UE may output an indication of the identified level of the condition for the environment based on the sparsity of the set of FFT coefficients or the set of DWT coefficients, such as described in connection with FIGS. 9-13. For example, the UE 902 may use the identified weather condition for setting or modifying driving related parameters, or provide the identified weather condition to a server. The output of the indication may be performed by, e.g., the weather detection component 198, the one or more sensor modules 1718 (e.g., one or more Lidar sensors), the camera 1732, the transceiver(s) 1722, the cellular baseband processor(s) 1724, and/or the application processor(s) 1706 of the apparatus 1704 in FIG. 17. In some implementations, to output the indication of the identified level of the condition for the environment, the UE may transmit the indication of the identified level of the condition for the environment, or the UE may store, in a memory or a cache, the indication of the identified level of the condition for the environment.

In another example, the UE may capture an image for the environment using at least one camera, and pair the captured image with at least one other image based on the sparsity of the set of FFT coefficients or the set of DWT coefficients, such as described in connection with FIG. 14. For example, as shown at 1402, a group of three range images may be used for construct positive and negative pairs for the triplet loss. As 1404, based on the pairing, corresponding camera images (e.g., taken approximately by a camera at the same time as the range image from a Lidar sensor) may be used for providing useful information and/or extracting features. The capturing of the image and/or the pairing of the captured image may be performed by, e.g., the weather detection component 198, the one or more sensor modules 1718 (e.g., one or more Lidar sensors), the camera 1732, the transceiver(s) 1722, the cellular baseband processor(s) 1724, and/or the application processor(s) 1706 of the apparatus 1704 in FIG. 17. In some implementations, the UE may train an artificial intelligence (AI)/machine learning (ML) (AI/ML) model to identify a set of features for the environment based on the pairing of the captured image with the at least one other image.

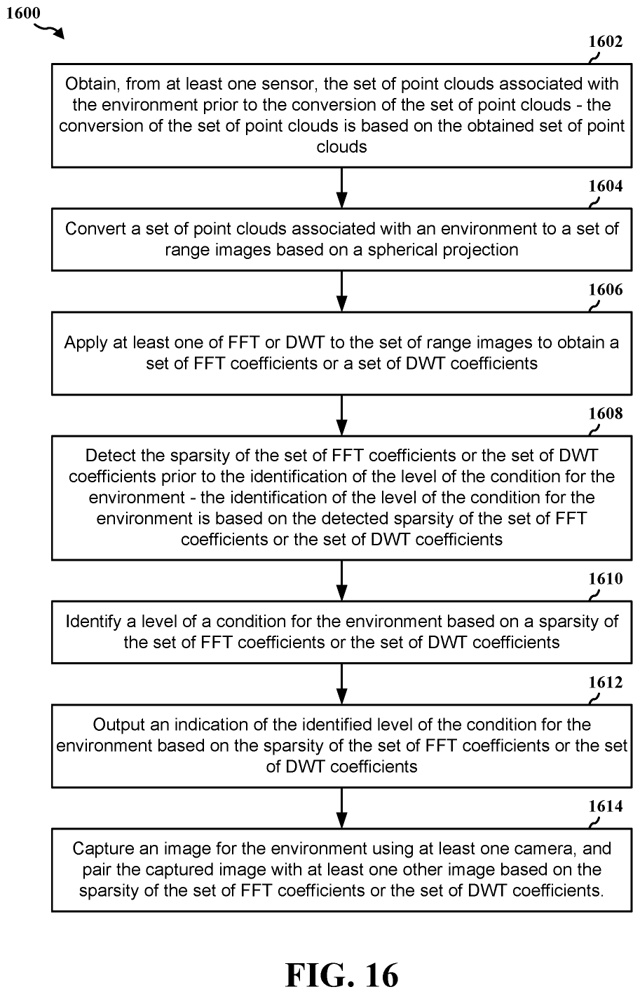

FIG. 16 is a flowchart 1600 of a method of wireless communication. The method may be performed by a UE (e.g., the UE 104, 404, 502, 506, 508, 902; the vehicle 602; the apparatus 1704). The method may enable the UE to detect and identify a weather condition based on the sparsity of FFT/DWT coefficients derived from a set of range images.

At 1604, the UE may convert a set of point clouds associated with an environment to a set of range images based on a spherical projection, such as described in connection with FIGS. 9-13. For example, as shown at 930 of FIG. 9, the UE 902 may convert a point cloud to a set of range images based on spherical projection. The conversion of the set of point clouds may be performed by, e.g., the weather detection component 198, the one or more sensor modules 1718 (e.g., one or more Lidar sensors), the camera 1732, the transceiver(s) 1722, the cellular baseband processor(s) 1724, and/or the application processor(s) 1706 of the apparatus 1704 in FIG. 17.

At 1606, the UE may apply at least one of FFT or DWT to the set of range images to obtain a set of FFT coefficients or a set of DWT coefficients, such as described in connection with FIGS. 9-13. For example, as shown at 940 of FIG. 10, the UE 902 may apply FFT and/or DWT to the set of range images to obtain a set of FFT/DWT coefficients. The application of the FFT or DWT may be performed by, e.g., the weather detection component 198, the one or more sensor modules 1718 (e.g., one or more Lidar sensors), the camera 1732, the transceiver(s) 1722, the cellular baseband processor(s) 1724, and/or the application processor(s) 1706 of the apparatus 1704 in FIG. 17.

At 1610, the UE may identify a level of a condition for the environment based on a sparsity of the set of FFT coefficients or the set of DWT coefficients, such as described in connection with FIGS. 9-13. For example, as shown at 950 of FIG. 11 and FIG. 12, the UE 902 may determine a weather condition based on the sparsity of the FFT/DWT coefficients. The identification of the level of the condition for the environment may be performed by, e.g., the weather detection component 198, the one or more sensor modules 1718 (e.g., one or more Lidar sensors), the camera 1732, the transceiver(s) 1722, the cellular baseband processor(s) 1724, and/or the application processor(s) 1706 of the apparatus 1704 in FIG. 17.

In one example, the condition may be an adverse weather condition or a clear weather condition, and to identify the level of the condition for the environment, the UE may identify the level of the adverse weather condition or the clear weather condition.

In another example, the sparsity of the set of FFT coefficients or the set of DWT coefficients may be based on an L1 norm.

In another example, the condition may be an adverse weather condition, and the adverse weather condition is more severe when the set of FFT coefficients or the set of DWT coefficients is denser compared to the set of FFT coefficients or the set of DWT coefficients that is less dense.

In another example, the set of point clouds corresponds to a three-dimensional (3D) visualization of the environment that comprises a plurality of georeferenced points.

In another example, the UE may modify at least one control parameter of a vehicle based on the identification of the level of the condition for the environment.

In another example, as shown at 1602, the UE may obtain, from at least one sensor, the set of point clouds associated with the environment prior to the conversion of the set of point clouds, where the conversion of the set of point clouds may be based on the obtained set of point clouds, such as described in connection with FIGS. 9-13. For example, as shown by FIG. 9, the UE 902 may obtain the point cloud for one or more objects 908 using one or more ranging components 904. The obtaining of the set of point clouds may be performed by, e.g., the weather detection component 198, the one or more sensor modules 1718 (e.g., one or more Lidar sensors), the camera 1732, the transceiver(s) 1722, the cellular baseband processor(s) 1724, and/or the application processor(s) 1706 of the apparatus 1704 in FIG. 17. In some implementations, the at least one sensor includes at least one light detection and ranging (Lidar) sensor. In some implementations, the UE may obtain the set of range images via multiple timestamps of one or more Lidar sensors, and to applying at least one of the FFT or the DWT to the set of range images, the UE may apply at least one of a three-dimensional (3D) FFT or a 3D DWT to the set of range images.

In another example, as shown at 1608, the UE may detect the sparsity of the set of FFT coefficients or the set of DWT coefficients prior to the identification of the level of the condition for the environment, where the identification of the level of the condition for the environment is based on the detected sparsity of the set of FFT coefficients or the set of DWT coefficients, such as described in connection with FIGS. 9-13. For example, as shown by FIG. 12, the UE 902 may detect the sparsity of the FFT/DWT coefficients for a scene/environment, where the weather condition (or the level of the adverse weather condition) may be based on the sparsity of the FFT/DWT coefficients or the set of DWT coefficients. The detection of the sparsity of the set of FFT/DWT coefficients may be performed by, e.g., the weather detection component 198, the one or more sensor modules 1718 (e.g., one or more Lidar sensors), the camera 1732, the transceiver(s) 1722, the cellular baseband processor(s) 1724, and/or the application processor(s) 1706 of the apparatus 1704 in FIG. 17.

In another example, as shown at 1612, the UE may output an indication of the identified level of the condition for the environment based on the sparsity of the set of FFT coefficients or the set of DWT coefficients, such as described in connection with FIGS. 9-13. For example, the UE 902 may use the identified weather condition for setting or modifying driving related parameters, or provide the identified weather condition to a server. The output of the indication may be performed by, e.g., the weather detection component 198, the one or more sensor modules 1718 (e.g., one or more Lidar sensors), the camera 1732, the transceiver(s) 1722, the cellular baseband processor(s) 1724, and/or the application processor(s) 1706 of the apparatus 1704 in FIG. 17. In some implementations, to output the indication of the identified level of the condition for the environment, the UE may transmit the indication of the identified level of the condition for the environment, or the UE may store, in a memory or a cache, the indication of the identified level of the condition for the environment.

In another example, as shown at 1614, the UE may capture an image for the environment using at least one camera, and pair the captured image with at least one other image based on the sparsity of the set of FFT coefficients or the set of DWT coefficients, such as described in connection with FIG. 14. For example, as shown at 1402, a group of three range images may be used for construct positive and negative pairs for the triplet loss. As 1404, based on the pairing, corresponding camera images (e.g., taken approximately by a camera at the same time as the range image from a Lidar sensor) may be used for providing useful information and/or extracting features. The capturing of the image and/or the pairing of the captured image may be performed by, e.g., the weather detection component 198, the one or more sensor modules 1718 (e.g., one or more Lidar sensors), the camera 1732, the transceiver(s) 1722, the cellular baseband processor(s) 1724, and/or the application processor(s) 1706 of the apparatus 1704 in FIG. 17. In some implementations, the UE may train an artificial intelligence (AI)/machine learning (ML) (AI/ML) model to identify a set of features for the environment based on the pairing of the captured image with the at least one other image.

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include at least one cellular baseband processor 1724 (also referred to as a modem) coupled to one or more transceivers 1722 (e.g., cellular RF transceiver). The cellular baseband processor(s) 1724 may include at least one on-chip memory 1724′. In some aspects, the apparatus 1704 may further include one or more subscriber identity modules (SIM) cards 1720 and at least one application processor 1706 coupled to a secure digital (SD) card 1708 and a screen 1710. The application processor(s) 1706 may include on-chip memory 1706′. In some aspects, the apparatus 1704 may further include a Bluetooth module 1712, a WLAN module 1714, an ultrawideband (UWB) module 1738, an SPS module 1716 (e.g., GNSS module), one or more sensor modules 1718 (e.g., barometric pressure sensor/altimeter; ultrawide band (UWB) sensor, motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, the UWB module 1738, and the SPS module 1716 may include an on-chip transceiver (TRX) (or in some cases, just a receiver (RX)). The Bluetooth module 1712, the WLAN module 1714, the UWB module 1738, and the SPS module 1716 may include their own dedicated antennas and/or utilize the antennas 1780 for communication. The cellular baseband processor(s) 1724 communicates through the transceiver(s) 1722 via one or more antennas 1780 with the UE 104 and/or with an RU associated with a network entity 1702. The cellular baseband processor(s) 1724 and the application processor(s) 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor(s) 1724 and the application processor(s) 1706 are each responsible for general processing, including the execution of software stored on the computer-readable medium/memory. The software, when executed by the cellular baseband processor(s) 1724/application processor(s) 1706, causes the cellular baseband processor(s) 1724/application processor(s) 1706 to perform the various functions described supra. The computer-readable medium/memory may also be used for storing data that is manipulated by the cellular baseband processor(s) 1724/application processor(s) 1706 when executing software. The cellular baseband processor(s) 1724/application processor(s) 1706 may be a component of the UE 350 and may include the at least one memory 360 and/or at least one of the TX processor 368, the RX processor 356, and the controller/processor 359. In one configuration, the apparatus 1704 may be at least one processor chip (modem and/or application) and include just the cellular baseband processor(s) 1724 and/or the application processor(s) 1706, and in another configuration, the apparatus 1704 may be the entire UE (e.g., see UE 350 of FIG. 3) and include the additional modules of the apparatus 1704.

As discussed supra, the weather detection component 198 may be configured to convert a set of point clouds associated with an environment to a set of range images based on a spherical projection. The weather detection component 198 may also be configured to apply at least one of FFT or DWT to the set of range images to obtain a set of FFT coefficients or a set of DWT coefficients. The weather detection component 198 may also be configured to identify a level of a condition for the environment based on a sparsity of the set of FFT coefficients or the set of DWT coefficients. The weather detection component 198 may be within the cellular baseband processor(s) 1724, the application processor(s) 1706, or both the cellular baseband processor(s) 1724 and the application processor(s) 1706. The weather detection component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1704 may include a variety of components configured for various functions. In one configuration, the apparatus 1704, and in particular the cellular baseband processor(s) 1724 and/or the application processor(s) 1706, may include means for converting a set of point clouds associated with an environment to a set of range images based on a spherical projection. The apparatus 1704 may further include means for applying at least one of FFT or DWT to the set of range images to obtain a set of FFT coefficients or a set of DWT coefficients. The apparatus 1704 may further include means for identifying a level of a condition for the environment based on a sparsity of the set of FFT coefficients or the set of DWT coefficients.

In one configuration, the condition may be an adverse weather condition or a clear weather condition, and to identify the level of the condition for the environment, the UE may identify the level of the adverse weather condition or the clear weather condition.

In another configuration, the sparsity of the set of FFT coefficients or the set of DWT coefficients may be based on an L1 norm.

In another configuration, the condition may be an adverse weather condition, and the adverse weather condition is more severe when the set of FFT coefficients or the set of DWT coefficients is denser compared to the set of FFT coefficients or the set of DWT coefficients that is less dense.

In another configuration, the set of point clouds corresponds to a three-dimensional (3D) visualization of the environment that comprises a plurality of georeferenced points.

In another configuration, the apparatus 1704 may further include means for modifying at least one control parameter of a vehicle based on the identification of the level of the condition for the environment.

In another configuration, the apparatus 1704 may further include means for obtaining, from at least one sensor, the set of point clouds associated with the environment prior to the conversion of the set of point clouds, where the conversion of the set of point clouds may be based on the obtained set of point clouds. In some implementations, the apparatus 1704 may further include means for obtain the set of range images via multiple timestamps of one or more Lidar sensors, and the means for applying at least one of the FFT or the DWT to the set of range images may include configuring the apparatus 1704 to apply at least one of a 3D FFT or a 3D DWT to the set of range images.

In another configuration, the apparatus 1704 may further include means for detecting the sparsity of the set of FFT coefficients or the set of DWT coefficients prior to the identification of the level of the condition for the environment, where the identification of the level of the condition for the environment is based on the detected sparsity of the set of FFT coefficients or the set of DWT coefficients.

In another configuration, the apparatus 1704 may further include means for outputting an indication of the identified level of the condition for the environment based on the sparsity of the set of FFT coefficients or the set of DWT coefficients. In some implementations, the means for outputting the indication of the identified level of the condition for the environment may include configuring the apparatus 1704 to transmit the indication of the identified level of the condition for the environment, or to store, in a memory or a cache, the indication of the identified level of the condition for the environment.

In another configuration, the apparatus 1704 may further include means for capturing an image for the environment using at least one camera, and means for pairing the captured image with at least one other image based on the sparsity of the set of FFT coefficients or the set of DWT coefficients. In some implementations, the apparatus 1704 may further include means for training an AI/ML model to identify a set of features for the environment based on the pairing of the captured image with the at least one other image.

The means may be the weather detection component 198 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X. X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a user equipment (UE), comprising: converting a set of point clouds associated with an environment to a set of range images based on a spherical projection; applying at least one of Fast Fourier Transform (FFT) or Discrete Wavelet Transform (DWT) to the set of range images to obtain a set of FFT coefficients or a set of DWT coefficients; and identifying a level of a condition for the environment based on a sparsity of the set of FFT coefficients or the set of DWT coefficients.
Aspect 2 is the method of aspect 1, further comprising: outputting an indication of the identified level of the condition for the environment based on the sparsity of the set of FFT coefficients or the set of DWT coefficients.
Aspect 3 is the method of aspect 1 or aspect 2, wherein outputting the indication of the identified level of the condition for the environment comprises: transmitting the indication of the identified level of the condition for the environment; or storing, in a memory or a cache, the indication of the identified level of the condition for the environment.
Aspect 4 is the method of any of aspects 1 to 3, further comprising: detecting the sparsity of the set of FFT coefficients or the set of DWT coefficients prior to the identification of the level of the condition for the environment, wherein the identification of the level of the condition for the environment is based on the detected sparsity of the set of FFT coefficients or the set of DWT coefficients.
Aspect 5 is the method of any of aspects 1 to 4, wherein the condition is an adverse weather condition or a clear weather condition, and wherein identifying the level of the condition for the environment comprises identifying the level of the adverse weather condition or the clear weather condition.
Aspect 6 is the method of any of aspects 1 to 5, wherein the sparsity of the set of FFT coefficients or the set of DWT coefficients is based on an L1 norm.
Aspect 7 is the method of any of aspects 1 to 6, further comprising: obtaining, from at least one sensor, the set of point clouds associated with the environment prior to the conversion of the set of point clouds, wherein the conversion of the set of point clouds is based on the obtained set of point clouds.
Aspect 8 is the method of any of aspects 1 to 7, wherein the at least one sensor includes at least one light detection and ranging (Lidar) sensor.
Aspect 9 is the method of any of aspects 1 to 8, further comprising: obtaining the set of range images via multiple timestamps of one or more Lidar sensors, and wherein applying at least one of the FFT or the DWT to the set of range images comprises: applying at least one of a three-dimensional (3D) FFT or a 3D DWT to the set of range images.
Aspect 10 is the method of any of aspects 1 to 9, wherein the condition is an adverse weather condition, and wherein the adverse weather condition is more severe when the set of FFT coefficients or the set of DWT coefficients is denser compared to the set of FFT coefficients or the set of DWT coefficients that is less dense.
Aspect 11 is the method of any of aspects 1 to 10, further comprising: capturing an image for the environment using at least one camera; and pairing the captured image with at least one other image based on the sparsity of the set of FFT coefficients or the set of DWT coefficients.
Aspect 12 is the method of any of aspects 1 to 11, further comprising: training an artificial intelligence (AI)/machine learning (ML) (AI/ML) model to identify a set of features for the environment based on the pairing of the captured image with the at least one other image.
Aspect 13 is the method of any of aspects 1 to 12, wherein the set of point clouds corresponds to a three-dimensional (3D) visualization of the environment that comprises a plurality of georeferenced points.
Aspect 14 is the method of any of aspects 1 to 13, further comprising: modifying at least one control parameter of a vehicle based on the identification of the level of the condition for the environment.
Aspect 15 is an apparatus for wireless communication at a user equipment (UE), including: at least one memory; and at least one processor coupled to the at least one memory and, based at least in part on information stored in the at least one memory, the at least one processor, individually or in any combination, is configured to implement any of aspects 1 to 14.
Aspect 16 is the apparatus of aspect 15, further including at least one of a transceiver or an antenna coupled to the at least one processor.
Aspect 17 is an apparatus for wireless communication including means for implementing any of aspects 1 to 14.
Aspect 18 is a computer-readable medium (e.g., a non-transitory computer-readable medium) storing computer executable code, where the code when executed by a processor causes the processor to implement any of aspects 1 to 14.

What is claimed is:

1. An apparatus for wireless communication at a user equipment (UE), comprising:
a transceiver;
at least one memory; and
at least one processor coupled to the at least one memory and, based at least in part on information stored in the at least one memory, the at least one processor, individually or in any combination, is configured to:
convert a set of point clouds associated with an environment to a set of range images based on a spherical projection;
apply at least one of Fast Fourier Transform (FFT) or Discrete Wavelet Transform (DWT) to the set of range images to obtain a set of FFT coefficients or a set of DWT coefficients; and
identify a level of a condition for the environment based on a sparsity of the set of FFT coefficients or the set of DWT coefficients.

2. The apparatus of claim 1, wherein the at least one processor, individually or in any combination, is further configured to:
output an indication of the identified level of the condition for the environment based on the sparsity of the set of FFT coefficients or the set of DWT coefficients.

3. The apparatus of claim 2, wherein to output the indication of the identified level of the condition for the environment, the at least one processor, individually or in any combination, is configured to:
transmit the indication of the identified level of the condition for the environment; or
store, in a memory or a cache, the indication of the identified level of the condition for the environment.

4. The apparatus of claim 1, wherein the at least one processor, individually or in any combination, is further configured to:
detect the sparsity of the set of FFT coefficients or the set of DWT coefficients prior to the identification of the level of the condition for the environment, wherein the identification of the level of the condition for the environment is based on the detected sparsity of the set of FFT coefficients or the set of DWT coefficients.

5. The apparatus of claim 1, wherein the condition is an adverse weather condition or a clear weather condition, and wherein to identify the level of the condition for the environment, the at least one processor, individually or in any combination, is configured to identify the level of the adverse weather condition or the clear weather condition.

6. The apparatus of claim 1, wherein the sparsity of the set of FFT coefficients or the set of DWT coefficients is based on an L1 norm.

7. The apparatus of claim 1, wherein the at least one processor, individually or in any combination, is further configured to:
obtain, from at least one sensor, the set of point clouds associated with the environment prior to the conversion of the set of point clouds, wherein the conversion of the set of point clouds is based on the obtained set of point clouds.

8. The apparatus of claim 7, wherein the at least one sensor includes at least one light detection and ranging (Lidar) sensor.

9. The apparatus of claim 8, wherein the at least one processor, individually or in any combination, is further configured to:
obtain the set of range images via multiple timestamps of one or more Lidar sensors, and wherein to apply at least one of the FFT or the DWT to the set of range images, the at least one processor, individually or in any combination, is configured to:
apply at least one of a three-dimensional (3D) FFT or a 3D DWT to the set of range images.

10. The apparatus of claim 1, wherein the condition is an adverse weather condition, and wherein the adverse weather condition is more severe when the set of FFT coefficients or the set of DWT coefficients is denser compared to the set of FFT coefficients or the set of DWT coefficients that is less dense.

11. The apparatus of claim 1, wherein the at least one processor, individually or in any combination, is further configured to:
capture an image for the environment using at least one camera; and
pair the captured image with at least one other image based on the sparsity of the set of FFT coefficients or the set of DWT coefficients.

12. The apparatus of claim 11, wherein the at least one processor, individually or in any combination, is further configured to:
train an artificial intelligence (AI)/machine learning (ML) (AI/ML) model to identify a set of features for the environment based on the pairing of the captured image with the at least one other image.

13. The apparatus of claim 1, wherein the set of point clouds corresponds to a three-dimensional (3D) visualization of the environment that comprises a plurality of georeferenced points.

14. The apparatus of claim 1, wherein the at least one processor, individually or in any combination, is further configured to:
modify at least one control parameter of a vehicle based on the identification of the level of the condition for the environment.

15. A method of wireless communication at a user equipment (UE), comprising:
converting a set of point clouds associated with an environment to a set of range images based on a spherical projection;
applying at least one of Fast Fourier Transform (FFT) or Discrete Wavelet Transform (DWT) to the set of range images to obtain a set of FFT coefficients or a set of DWT coefficients; and
identifying a level of a condition for the environment based on a sparsity of the set of FFT coefficients or the set of DWT coefficients.

16. The method of claim 15, further comprising:
outputting an indication of the identified level of the condition for the environment based on the sparsity of the set of FFT coefficients or the set of DWT coefficients.

17. The method of claim 16, wherein outputting the indication of the identified level of the condition for the environment comprises:
transmitting the indication of the identified level of the condition for the environment; or
storing, in a memory or a cache, the indication of the identified level of the condition for the environment.

18. The method of claim 15, further comprising:
detecting the sparsity of the set of FFT coefficients or the set of DWT coefficients prior to the identification of the level of the condition for the environment, wherein the identification of the level of the condition for the environment is based on the detected sparsity of the set of FFT coefficients or the set of DWT coefficients.

19. The method of claim 15, wherein the condition is an adverse weather condition or a clear weather condition, and wherein identifying the level of the condition for the environment comprises identifying the level of the adverse weather condition or the clear weather condition.

20. The method of claim 15, wherein the sparsity of the set of FFT coefficients or the set of DWT coefficients is based on an L1 norm.

21. The method of claim 15, further comprising:
obtaining, from at least one sensor, the set of point clouds associated with the environment prior to the conversion of the set of point clouds, wherein the conversion of the set of point clouds is based on the obtained set of point clouds.

22. The method of claim 21, wherein the at least one sensor includes at least one light detection and ranging (Lidar) sensor.

23. The method of claim 22, further comprising:
obtaining the set of range images via multiple timestamps of one or more Lidar sensors, and wherein applying at least one of the FFT or the DWT to the set of range images comprises:
applying at least one of a three-dimensional (3D) FFT or a 3D DWT to the set of range images.

24. The method of claim 15, wherein the condition is an adverse weather condition, and wherein the adverse weather condition is more severe when the set of FFT coefficients or the set of DWT coefficients is denser compared to the set of FFT coefficients or the set of DWT coefficients that is less dense.

25. The method of claim 15, further comprising:
capturing an image for the environment using at least one camera; and
pairing the captured image with at least one other image based on the sparsity of the set of FFT coefficients or the set of DWT coefficients.

26. The method of claim 25, further comprising:
training an artificial intelligence (AI)/machine learning (ML) (AI/ML) model to identify a set of features for the environment based on the pairing of the captured image with the at least one other image.

27. The method of claim 15, wherein the set of point clouds corresponds to a three-dimensional (3D) visualization of the environment that comprises a plurality of georeferenced points.

28. The method of claim 15, further comprising:
modifying at least one control parameter of a vehicle based on the identification of the level of the condition for the environment.

29. An apparatus for wireless communication at a user equipment (UE), comprising:
means for converting a set of point clouds associated with an environment to a set of range images based on a spherical projection;
means for applying at least one of Fast Fourier Transform (FFT) or Discrete Wavelet Transform (DWT) to the set of range images to obtain a set of FFT coefficients or a set of DWT coefficients; and
means for identifying a level of a condition for the environment based on a sparsity of the set of FFT coefficients or the set of DWT coefficients.

30. A computer-readable medium storing computer executable code at a user equipment (UE), the code when executed by at least one processor causes the at least one processor to:
convert a set of point clouds associated with an environment to a set of range images based on a spherical projection;
apply at least one of Fast Fourier Transform (FFT) or Discrete Wavelet Transform (DWT) to the set of range images to obtain a set of FFT coefficients or a set of DWT coefficients; and
identify a level of a condition for the environment based on a sparsity of the set of FFT coefficients or the set of DWT coefficients.
